(19) United States
(12) Patent Application Publication
(10) Pub. No.: US 2008/0058495 A1
(43) Pub. Date: Mar. 6, 2008

(54) Polyester polymer and copolymer compositions containing titanium and yellow colorants

(76) Inventors: Donna Rice Quillen, Kingsport, TN (US); Robert Joseph Maleski, Kingsport, TN (US); Max Allen Weaver, Kingsport, TN (US); James Christopher Scanlan, Kingsport, TN (US); Emily Fraser, Cockermouth (GB); Colin Milton, Cockermouth (GB); Wim Hoenderdaal, Ede (NL)

Correspondence Address: DENNIS V. CARMEN, EASTMAN CHEMICAL COMPANY, 100 NORTH EASTMAN ROAD, KINGSPORT, TN, 37660-5075, US

(21) Appl. No.: 11/594,282

(22) Filed: Nov. 8, 2006

Related U.S. Application Data
(60) Provisional application No. 60/842,253, filed on Sep. 5, 2006.

(51) Int. Cl. C08G 63/02

(52) U.S. Cl. 528/272

(57) ABSTRACT

There is provided a process for increasing the yellowness of polyester polymer particles, preforms, bottles, and concentrates, containing a polyester polymer such as polyethylene terephthalate and copolymers by adding a yellow colorant and reheat agent particles comprising titanium, alloys of titanium, titanium nitride, titanium boride, titanium carbide, or combinations thereof to a melt phase polymerization process for making the polyester polymer to adding any one of the colorant or particles to a polyester polymer.

This application claims priority to Provisional Application number 60/842,253 filed on Sep. 5, 2006.

### 1. FIELD OF THE INVENTION

The invention relates to polyester compositions that are useful in packaging, such as in the manufacture of beverage containers by reheat blow molding, or other hot forming processes in which polyester is reheated. The compositions of the invention may exhibit improved reheat and improved ability to block ultraviolet light, while exhibiting a pleasing visual appearance, through good clarity and more neutral color by increasing the yellowness of the polymer.

### 2. BACKGROUND OF THE INVENTION

Many plastic packages, such as those made from poly(ethylene terephthalate) (PET) and used in beverage containers, are formed by reheat blow-molding, or other operations that require heat softening of the polymer.

In reheat blow-molding, bottle preforms, which are test-tube shaped injection moldings, are heated above the glass transition temperature of the polymer, and then positioned in a bottle mold to receive pressurized air through their open end. This technology is well known in the art, as shown, for example in U.S. Pat. No. 3,733,309, incorporated herein by reference. In a typical blow-molding operation, radiation energy from quartz infrared heaters is generally used to reheat the preforms.

In the preparation of packaging containers using operations that require heat softening of the polymer, the reheat time, or the time required for the preform to reach the proper temperature for stretch blow molding (also called the heat-up time), affects both the productivity and the energy required. As processing equipment has improved, it has become possible to produce more units per unit time. Thus it is desirable to provide polyester compositions which provide improved reheat properties, by reheating faster (increased reheat rate), or with less reheat energy (increased reheat efficiency), or both, compared to conventional polyester compositions.

The aforementioned reheat properties vary with the absorption characteristics of the polymer itself. Heat lamps used for reheating polymer preforms are typically infrared heaters, such as quartz infrared lamps, having a broad light emission spectrum, with wavelengths ranging from 500 nm to greater than 1,500 nm. However, polyesters, especially PET, absorb electromagnetic radiation poorly in the region from 500 nm to 1,500 nm. Thus, in order to maximize energy absorption from the lamps and increase the preform reheat rate, materials that will increase infrared energy absorption are sometimes added to PET. Unfortunately, these materials tend to have a negative effect on the visual appearance of PET containers, for example increasing the haze level and/or causing the article to have a dark appearance. Further, since compounds with absorbance in the visible light wavelength range (400 nm to 700 nm) appear colored to the human eye, materials that absorb and/or scatter visible light will impart color to the polymer.

A variety of black and gray body absorbing compounds have been used as reheat agents to improve the reheat characteristics of polyester preforms under reheat lamps. These conventional reheat additives include carbon black, graphite, antimony metal, black iron oxide, red iron oxide, inert iron compounds, spinel pigments, and infrared-absorbing dyes. The amount of absorbing compound that can be added to a polymer is limited by its impact on the visual properties of the polymer, such as brightness, which may be expressed as an L* value, and color, which is measured and expressed as an a* value, a b* value, and haze, as further described below.

To retain an acceptable level of brightness and color in the preform and resulting blown articles, the quantity of reheat additive may be decreased, which in turn decreases reheat rates. Thus, the type and amount of reheat additive added to a polyester resin may be adjusted to strike the desired balance between increasing the reheat rate and retaining acceptable brightness and color levels.

Due to aesthetic reasons, a neutral color is normally desired in polyester beverage containers. A blue tinge is sometimes desired in containers for water applications. Yellowness, which may be measured as b* values in the CIE color system, has been a particularly undesirable color in consumer packaging, and bluing agents such as cobalt and organic toners have been used to increase the blue tint of consumer packaging, thus shifting the b* value from yellow to blue (or from higher to lower b* values), creating a more appealing package.

While polyesters used for packaging, such as PET and its copolymers, have been adapted for use as containers for a wide range of consumer products, their inability to block ultraviolet (UV) light of certain wavelengths has made them less well-suited for use in the packaging of products subject to photo-degradation, such as fruit juices, soft drinks, wines, food products, cosmetics, shampoos, and products containing UV-sensitive dyes. Ultraviolet light is not visible to the naked eye, having a wavelength from 100 nm to 400 nm, and is subdivided into UV-C having a wavelength from 100 nm to 280 nm, UV-B having a wavelength from 280 nm to 315 nm, and UV-A having a wavelength from 315 nm to 400 nm. Although polyesters such as PET block much of the ultraviolet light from 100 nm up to 315 nm, they are less effective at blocking UV-A light from 315 nm to 400 nm. U.S. Pat. No. 4,617,374, related to the use of polymerizable UV-blocking agents (the disclosure of which is incorporated herein by reference in its entirety), describes some of the known effects of ultraviolet light on packaged products, and offers the ability to block a portion of the ultraviolet light to which the container is exposed by the use of such blocking agents. Clearly, an additive which may provide a polyester composition having improved reheat, or improved bluing, or improved UV-blocking, or any combination of these advantages, would make the resulting polyester article suitable in the packaging of a wide range of consumer products. These problems were solved as disclosed in prior copending applications US Publication No. 200600106146 and U.S. Ser. No. 05/00229238. The ability of certain reheat agents, such as titanium based compounds and in particular titanium nitride, when added to the manufacture of the polyester polymer in the melt phase polymerization process, has provided polyester polymers which, when injection molded and stretch blow molded, provide preforms and bottles which have excellent reheat times, UV stability, and tinted in the blue region. However, the successful application of these reheat particles has produced an unexpected phenomena in that the preforms and bottles made therefrom are quite blue, into the region of having a b* ranging from 0 to −15. Cutting back on the amount of titanium-based reheat particles which contribute to the blueness reduces the amount of blueness imparted to the preform and bottle, but below certain levels, the reheat rate improvements are diminished. It would be desirable to obtain a polyester polymer which has a b* more close to the neutral range and which does not require cutting back on the amount of titanium based reheat particles in order to achieve a color b* color closer to neutral, or in the alternative as described below, provides an alternative method for controlling color while retaining the flexibility to retain or adjust the amount of titanium based reheat particles while obtaining a consistent b* color target.

The color imparted to a particular polymer produced on a commercial line is dependent upon a number of variables, including the quality of purified terephthalic acid; the temperature and pressure applied to the polymer melt; the residence time of the melt; the reactor configuration; the consistency of the quantity of catalyst systems added and reheat agents added, and the type of catalyst used. Changing any one of these variables may affect the b* color of the polyester polymer. Even when process settings are maintained the same on a commercial line, the quality of additives and purified terephthalic acid obtained from suppliers can vary from batch to batch. Moreover, commercial lines may need to run for a period of time to produce a polymer having one level of reheat improvement, and thereafter switch to produce polymers having a different level of reheat improvement. Since certain titanium reheat agents affect both the reheat rate and the b* color imparting a blueness to the polymer, changing the amount of titanium reheat additive from run to run also affects the color. However, customers of polyester polymers desire b* color consistency on each shipment of polymer, sometimes even if the reheat improvement changes, so as to produce preforms and bottles having consistent color. It is therefore desirable to have a production method which allows for controlling the polymer b* to a targeted level or which diminishes the otherwise wide swings in b* color independent of the changes the quality of terephthalic acid and the level of titanium reheat agent.

### 3. SUMMARY OF THE INVENTION

There is now provided a process for increasing the yellowness of a polyester polymer, comprising adding:
a. reheat agent particles comprising titanium, alloys of titanium, titanium nitride, titanium boride, titanium carbide, or combinations thereof; and
b. a yellow colorant

to a melt phase polymerization process for manufacturing a polyester polymer.

Preferably, the polyester polymer composition produced by the polymerization process has a b* ranging from −5 to +5.

In one embodiment, the polyester polymer has a b* ranging from less than 0 to −15 in the absence of the yellow colorant.

In another embodiment, there is provided a process for increasing the yellowness of an article, comprising adding to a melt processing zone for making said article a feed of polyester polymer particles and:
a) reheat agent particles comprising titanium, alloys of titanium, titanium nitride, titanium boride, titanium carbide, or combinations thereof, and
c) a yellow colorant.

There is also provided polyester composition comprising a melt, solid particles, food containers, or beverage containers, comprising a polyester polymer and:
a. reheat agent particles comprising titanium, alloys of titanium, titanium nitride, titanium boride, titanium carbide, or combinations thereof; and
b. a yellow colorant

In each of these embodiments, the polyester polymer may also contain, or to a polyester polymer may be added, or to a melt phase process for making the polyester polymer may be added an orange and/or red colorant, particularly when the yellow colorant used is a greenish yellow colorant with a λmax in the visible spectrum at 430 nm or less or when one desires to obtain a neutral colored polymer, where λmax is defined as the wavelength of the minimium percent transmittance (i.e. maximum absorbance) in a scan of transmittance versus wavelength obtained by an optical spectrometer.

### 4. DETAILED DESCRIPTION OF THE INVENTION

The present invention may be understood more readily by reference to the following detailed description of the invention, and to the examples provided. It is to be understood that this invention is not limited to the specific processes and conditions described, because specific processes and process conditions for processing plastic articles may vary. It is also to be understood that the terminology used is for the purpose of describing particular embodiments only and is not intended to be limiting. It is further understood that although the various embodiments may achieve one or more advantages, the claimed invention is not restricted to those advantages, nor need all the advantages be obtained in every instance.

As used in the specification and the claims, the singular forms “a,” “an,” and “the” include plural referents unless the context clearly dictates otherwise. For example, reference to processing a thermoplastic “preform,” “container” or “bottle” is intended to include the processing of a plurality of thermoplastic preforms, articles, containers, or bottles.

By “comprising” or “containing” we mean that at least the named compound, element, particle, etc. must be present in the composition or article, but does not exclude the presence of other compounds, materials, particles, etc., even if the other such compounds, material, particles, etc. have the same function as what is named.

As used herein, a particle size or median particle size means the d₅₀ particle size, which is the median diameter, where 50% of the volume is composed of particles larger than the stated d₅₀ value, and 50% of the volume is composed of particles smaller than the stated d₅₀ value. The particle size may be measured with a laser diffraction type particle size distribution meter, or scanning or transmission electron microscopy methods, or size exclusion chromatography. Alternatively, the particle size can be correlated by a percentage of particles screened through a mesh.

In one embodiment of the invention, there is provided a process for increasing the yellowness of a polyester polymer, comprising adding:
a. reheat agent particles comprising titanium, alloys of titanium, titanium nitride, titanium boride, titanium carbide, or combinations thereof; and
b. a yellow colorant

to a melt phase polymerization process for manufacturing a polyester polymer composition. Preferably, the polyester polymer composition has a b* ranging from −5 to +5, or above −2 to +5, or −2 to +3, or 0 to +3. Desirably, the polymer contains a combination of the yellow colorant and an orange colorant, or a red colorant, or a combination thereof. Moreover, the polymer desirably has a preform a* color value ranging from −4 to 2. Each feature is now described in further detail below.

The melt phase polymerization process is desirably continuous, but may also be conducted in a batch mode. In one embodiment, the melt phase process, whether batch or continuous, produces 10 metric tons of polyester polymer per year, or at least 30 metric tons, or at least 60 metric tons, or at least 100 metric tons, or at least 130 metric tons of polyester polymer per year, and the process is preferably continuous and the particles produced by the process are preferably made in a continuous process.

Reheat agent particles are particles which improve the reheat rate of the polyester polymer in which they are distributed. The reheat agent particles are titanium based particles within the polymer matrix. The reheat agent particles comprise titanium, titanium nitride, titanium boride, titanium carbide, or combinations thereof.

An improvement in the reheat rate means that the compositions reheat faster (increased reheat rate), or with less reheat energy (increased reheat efficiency), or both, compared to the same polyester composition without these titanium based reheat agent particles. A convenient measure is the reheat improvement temperature (RIT) of the compositions, as further defined herein.

In one embodiment, the reheat agent particles may provide one or more of the following effects to the polyester polymer, preform, and/or bottle made thereby in addition to improving the reheat properties of the polyester compositions in which they are distributed: a bluing agent to increase the blue tint of the polyester compositions in which they are distributed; and improving the UV-blocking properties of the polyester compositions in which they are distributed. Of course, the polyester compositions of the invention may have additional effects beyond those just given, and the invention is intended to encompass such additional effects as well.

Some titanium-based reheat agent particles increase the blue color of the polymer. This may be observed by a decrease in the b* value, as measured using the CIELAB scale, as further described herein, relative to the absence of the reheat agent particles. For example, the b* value may be lowered by at least 1 unit, or at least 2 units, or at least 3 units, or at least 5 units, or at least 8 units, or at least 10 units by the addition of the reheat agent particles.

The L* of the preforms and bottles may vary depending upon the desired application. In one embodiment, the polyester polymer particles, and articles made thereby including preforms and bottles, desirably have an L* of at least 65, or at least 68, or at least 70, or at least 72, or at least 75.

The reheat agents also provide, in a preferred embodiment, an increase in the UV-blocking effect by observing an increased resistance of the contents of a container to the effects of ultraviolet light. This phenomenon can be determined by visual inspection of contents such as dyes that degrade over time in the presence of UV light. Alternatively, the UV-blocking effect of the polyester compositions of the invention can be measured by UV-VIS measurements, such as by using a HP8453 Ultraviolet-Visible Diode Array Spectrometer, performed from a wavelength ranging from 200 nm to 460 nm. An effective comparison measure using this equipment would be a reduction in the percent of UV transmission rate at 370 nm, the polyester compositions of the invention typically obtaining a reduction of at least 5%, or at least 10%, or at least 20% when compared with polyester compositions without the reheat agent particles. For example, if the unmodified polymer exhibits a transmission rate of 80%, and the modified polymer exhibits a transmission rate of 60%, the reduction would be a reduction of 25%. Any other suitable measure of the ability of the polyester compositions to block a portion of the UV light incident upon the compositions may likewise be used. A suitable sample thickness, for purposes of approximating the thickness of a bottle side-wall, might be, for example, 0.012 inches thick, or from 0.008 to 0.020 inches thick.

One of the reheat agent particles which are useful in the invention comprises titanium nitride. Titanium nitride is commonly considered to be a compound of titanium and nitrogen in which there is approximately a one-to-one correspondence between titanium atoms and nitrogen atoms. However, it is known in the art of metallurgy that titanium nitride, having a cubic NaCl-type structure, is stable over a wide range of anion or cation deficiencies, for example in relative amounts from TiN_{0.42} to TiN_{1.0}, or even, for example, to TiN_{1.16},(for example, if titanium nitride is prepared at low temperatures by reacting NH₃ with TiCl₄, see pg. 87, Transition Metal Carbides and Nitrides, by Louis E. Toth, 1971, Academic Press (London), incorporated herein by reference) all of which compounds are intended to fall within the scope of the invention.

Although titanium nitride particles are one kind of reheat agent particle suitable for use in the invention, the titanium nitride particles may comprise significant amounts of titanium carbide and/or titanium oxide, so long as the titanium nitride particles are comprised of significant amounts of the titanium nitride, or so long as the total amount of titanium nitride and titanium carbide is at least 50 wt. %, for example. Thus, the titanium nitride may have relative amounts of titanium, carbon, and nitrogen within a wide range, such as a relative stoichiometry up to TiC_{0.5}N_{0.5}, or to TiC_{0.8}N_{0.2}, or to TiC_{0.7}N_{0.3} or even greater, with the carbon replacing nitrogen, and with the relative amounts of titanium to nitrogen (or nitrogen and carbon) as already described. Of course, the amount of titanium carbide phase which is present in the particles is not at all critical

Titanium nitride compounds useful according to the claimed invention include those further described in Kirk-Othmer Encyclopedia of Chemical Technology, Vol 24, 4th ed., (1997) pp. 225-349, and especially pp. 231-232, the relevant portions of which are incorporated herein by reference.

Titanium nitride particles useful according to the claimed invention may be distinguished from other titanium compounds, such as those used as condensation catalysts, for example titanium alkoxides or simple chelates. That is, if titanium compounds are used as condensation catalysts to form the polymer in the compositions of the claimed invention, such polymers will additionally contain the reheat agent particles as described herein.

The reheat agent particles and in particular titanium nitride particles, in one embodiment, have a median particle size of less than 0.04 micrometers (μm), and a relatively narrow particle size distribution, are advantageous as both bluing agents and reheat additives.

The reheat particles may include one or more other metals or impurities, so long as the particles are comprised of significant amounts of the specified titanium containing particles. Preferably, the amount of other metals or non-metals present in the particles is preferably no more than 50 wt. % of the particle, such other elements including aluminum, tin, zirconium, manganese, germanium, iron, chromium, tungsten, molybdenum, vanadium, palladium, ruthenium, niobium, tantalum, cobalt, nickel, copper, gold, silver, silicon, and hydrogen, as well as carbon and oxygen, as already described. In another aspect, the amount of other metals or non-metals, other than carbon, nitrogen, or boron, present in the particles is no more than 40 wt. %, or no more than 30 wt. %, or no more than 20 wt. %, or no more than 10 wt. %, or no more than 5 wt. %, or no more than 3 wt. % of the reheat agent particle, such other elements including aluminum, tin, zirconium, manganese, germanium, iron, chromium, tungsten, molybdenum, vanadium, palladium, ruthenium, niobium, tantalum, cobalt, nickel, copper, gold, silver, silicon, oxygen, and hydrogen.

The reheat agent particles may comprise at least 50 wt. %, or at least 60 wt. %, or at least 75 wt. %, or at least 90 wt. %, or at least 95 wt. % titanium nitride, titanium, titanium boride, titanium carbide, or combinations thereof.

The particles may be hollow spheres or spheroids coated with one or more of the elements or compounds described as the reheat agent particles. The coating thickness should be sufficient to provide adequate reheat properties. Thus, in various embodiments, the thickness of the coating may be from 0.005 μm to 10 μm, or from 0.01 μm to 5 μm, or from 0.01 μm to 0.5 μm. Alternatively, the coating thickness may range even smaller, such as from 0.5 nm to 100 nm, or from 0.5 nm to 50 nm, or from 0.5 nm to 10 nm.

The amount of reheat agent particles present in the polyester compositions according to the invention may vary within a range, for example from 0.5 ppm, or from 1 ppm, or from 2 ppm, or from 3 ppm, up to 1,000 ppm, or up to 500 ppm, or up to 200 ppm, or up to 100 ppm, or up to 50 ppm, or up to 25 ppm, or up to 15 ppm, or up to 13 ppm, or up to 10 ppm, or up to 8 ppm, or up to 7 ppm, or up to 6 ppm, or up to 5 ppm. For example, in some instances, loadings from 1 ppm to 20 ppm, or 2 to 18 ppm, or 3 to 15 ppm, or 3 to 10 ppm, or 3 to 7 ppm, may be entirely adequate for improved reheat.

It should be noted that titanium nitride particles can be produced by numerous techniques, such as reacting the metal or oxide of titanium with nitrogen, or by plasma arc vapor synthesis, in which TiCl₄ is reacted with NH₃. Further details are described in the Powder Metallurgy entry in Kirk-Othmer Encyclopedia of Chemical Technology, Vol 16, 4th ed., (1995) pp. 353-392; details can also be found in Transition Metal Carbides and Nitrides by L. E. Toth, Academic Press 1971, pp 1-28, each of which is incorporated herein by reference. The titanium nitride particles according to the invention may thus be produced by any known means, without limitation.

Shapes of reheat agent particles which can be used in this invention include, but are not limited to, the following: acicular powder, angular powder, dendritic powder, equi-axed powder, flake powder, fragmented powder, granular powder, irregular powder, nodular powder, platelet powder, porous powder, rounded powder, and spherical powder. The particles may be of a filamentary structure, where the individual particles may be loose aggregates of smaller particles attached to form a bead or chain-like structure. The overall size of the particles may be variable, due to a variation in chain length and degree of branching.

In further embodiments, there is provided reheat agent particles, such as titanium nitride, having a particle size from 1 nm to 500 nm, or from 1 nm to 300 nm, or from 10 nm to 100 nm, or from 10 nm to 80 nm, present at a concentration ranging from 1 ppm to 100 ppm, or from 3 ppm to 30 ppm, or from 3 ppm to 15 ppm, or any other range as described above.

The reheat agent particles may have irregular shapes and form chain-like structures, although roughly spherical particles may be preferred. The particle size and particle size distribution may be measured by methods such as those described in the Size Measurement of Particles entry of Kirk-Othmer Encyclopedia of Chemical Technology, Vol. 22, 4th ed., (1997) pp. 256-278, incorporated herein by reference. For example, particle size and particle size distributions may be determined using a Fisher Subsieve Sizer or a Microtrac Particle-Size Analyzer manufactured by Leeds and Northrop Company, or by microscopic techniques, such as scanning electron microscopy or transmission electron microscopy.

A range of particle size distributions may be useful according to the invention. The particle size distribution, as used herein, may be expressed by “span (S),” where S is calculated by the following equation:

$$S = \frac{{d}_{90} - {d}_{10}}{{d}_{50}}$$

where d₉₀ represents a particle size in which 90% of the volume is composed of particles having a diameter smaller than the stated d₉₀; and d₁₀ represents a particle size in which 10% of the volume is composed of particles having a diameter smaller than the stated d₁₀; and d₅₀ represents a particle size in which 50% of the volume is composed of particles having a diameter larger than the stated d₅₀ value, and 50% of the volume is composed of particles having a diameter smaller than the stated d₅₀ value.

Thus, particle size distributions in which the span (S) is from 0 to 10, or from 0 to 5, or from 0.01 to 2, for example, may be used according to the invention. Alternatively, the particle size distribution (S) may range even broader, such as from 0 to 15, or from 0 to 25, or from 0 to 50.

In order to obtain a good dispersion of particles in the polyester compositions, a solid concentrate containing for example 300 ppm to 1000 ppm particles, or from 300 ppm to 1 wt %, or up to 40 wt %, or even higher, may be prepared using a polyester polymer. The concentrate may then be let down into a polyester at the desired concentration in the finished polymer, preform, or container, ranging in amounts as already described above. Alternatively, the reheat agent particles may be mixed in a liquid carrier as a slurry, dispersion, or emulsion and added to a polymerization melt phase polymerization process or to a melt processing zone fed with polyester polymer particles such as an extruder or an injection molding machine. The liquid carrier may be an inert solvent or a carrier reactive with the reactants used to make the polyester polymer or with the polyester polymer itself.

The location of the reheat agent particles within the polyester compositions is not limited. The particles may be disposed anywhere on or within the polyester polymer, pellet, preform, or bottle. Preferably, the polyester polymer in the form of a pellet forms a continuous phase. By being distributed “within” the continuous phase we mean that the particles are found at least within a portion of a cross-sectional cut of the pellet. The particles may be distributed within the polyester polymer randomly, distributed within discrete regions, or distributed only within a portion of the polymer. In a specific embodiment, the particles are disposed randomly throughout the polyester polymer composition as by way of adding the particles to a melt, or by mixing the particles with a solid polyester composition followed by melting and mixing.

The method by which the particles are incorporated into the polyester composition is illustrated by but not limited to the following. The particles can be added to the melt phase polymerization process, such as during esterification or ester exchange, during polycondensation, at any point in-between the reaction vessels or pipes, or after polycondensation but before solidification; or may be added to a melt processing zone fed by the polyester polymer particles or to the polymer melt within the melt processing zone, such as may be found in extruder barrels or injection molding machines; or may be added as a solid/solid blend with powder or pellets. They may be added at locations including, but not limited to, proximate the inlet to an esterification reactor, proximate the outlet of an esterification reactor, at a point between the inlet and the outlet of an esterification reactor, anywhere along a recirculation loop, proximate the inlet to a prepolymer reactor, proximate the outlet to a prepolymer reactor, at a point between the inlet and the outlet of a prepolymer reactor, proximate the inlet to a polycondensation reactor, or proximal to the outlet of a polycondensation final reactor, or at a point between the inlet and the outlet of a polycondensation reactor, or at a point after the outlet of a polycondensation reactor, preferably a final polycondensation reactor, and before a die for forming pellets.

In another aspect, the reheat agent particles may be added to a polyester polymer and fed to a melt processing zone (for ease referred to interchangeably with an extruder or an injection molding machine), fed by polyester polymer particles by any method, including feeding the reheat agent particles to the molten polymer in the injection molding machine, or by combining the reheat agent particles with a feed of polyester polymer to the injection molding machine, either by melt blending or by dry blending pellets and particles. The particles may be supplied neat, or in a concentrate form in a polyester polymer, or as a dispersion in a liquid or solid carrier. Examples of suitable carriers include carriers reactive with the polyester polymer or reactants used to form polyester polymer, and unreactive carriers. Reactive carriers desirably have number average molecular weight up to 8000, or up to 6000, or up to 5000, or up to 4000, or up to 3000, or up to 2000, and at least 50, or at least 100, or at least 200, or at least 300, or at least 400, or at least 500. Examples include ethylene glycol, polyethylene glycol, and glycerol monostearate. The carrier forms an emulsion, dispersion or slurry with the particles.

A concentrate may be added to a bulk polyester or anywhere along the different stages for manufacturing PET, in a manner such that the concentrate is compatible with the bulk polyester or its precursors. For example, the point of addition or the It.V. of the concentrate may be chosen such that the It.V. of the polyethylene terephthalate and the It.V. of the concentrate are similar, e.g. ±0.2 It.V. A concentrate can be made with an It.V. ranging from 0.3 dL/g to 1.1 dL/g to match the typical It.V. of a polyethylene terephthalate under manufacture in the polycondensation stage. Alternatively, a concentrate can be made with an It.V. similar to that of solid-stated pellets used at the injection molding stage (e.g. It.V. from 0.6 dL/g to 1.1 dL/g).

The particles may be added to an esterification reactor, such as with and through the ethylene glycol feed optionally combined with a phosphorus compound, to a prepolymer reactor, to a polycondensation reactor, or to solid pellets in a reactor for solid stating, or at any point in-between any of these stages. In each of these cases, the particles may be combined with PET or its precursors neat, as a concentrate containing PET, or diluted with a carrier. The carrier may be reactive to PET or may be non-reactive. The particles, whether neat or in a concentrate or in a carrier, and the bulk polyester, may be dried prior to mixing together. These particles may be dried in an atmosphere of dried air or other inert gas, such as nitrogen, and if desired, under sub-atmospheric pressure. Desirably, the reheat agent particles are added after esterification is complete (e.g. greater than 80% conversion), or added between esterification and polycondensation, or added to a polycondensation zone.

The impact of a reheat agent particle on the blue or yellow color of the polymer can be judged using the CIELAB scale. The b* value measures yellow to blue with yellow having positive values and blue negative values.

Color measurement theory and practice are discussed in greater detail in Principles of Color Technology, pp. 25-66 by Fred W. Billmeyer, Jr., John Wiley & Sons, New York (1981), incorporated herein by reference.

The CIELAB value (L*, a*, b*), for the purpose of measurement, is made on twenty-ounce bottle preforms having an outer diameter of 0.846 inches and a sidewall cross-sectional thickness of 0.154 inches, Specifying a particular preform a* or b* color value does not imply that the composition is a preform or that a preform having a particular sidewall cross-sectional thickness is actually used, but only that in the event the b* is measured on the composition in whatever form the composition may be found, the polyester composition employed is, for purposes of testing and evaluating the b* of the composition, injection molded to make a preform having a thickness of 0.154 inches, and the b* of that preform is measured. The results of the b* measurement on that preform determines the b* value of the composition in whatever form the composition may be. Thus, specifying a particular b* value or b* value range of a melt, powder, particle, preform, or bottle means that when the composition is made into a preform as described above for measurement purposes, the b* value of the preform will correspond to the stated b* value or be within the stated range, or the preform used to make the bottle will have a b* value as stated or be within the stated range. The same applies with respect to L* and a* determinations.

In one embodiment, the b* color coordinate value of the polyester composition, including solid polyester polymer particles, preform, or bottle ranges from greater than −5, or at least −4, or at least −3, or at least −2.5, or at least −2.0, or at least −1.5, or at least −1.0, or at least −0.5, and up to +5, or up to +4, or up to +3, or up to +2.5, or up to +2.0, or up to +1.5, or up to +1.0, or up to +0.5. Exemplary ranges are −3.0 up to +3.0, or −2.5 up to +2.5.

In another embodiment, the a* color coordinate value of the polyester composition, including solid polyester polymer particles, preform or bottle ranges from greater than −4, or at least −3, or at least −2.5 and up to 2, or up to 1. Exemplary ranges are −4 to 2, or −3 to 2, or −2.5 to 1. The polyester polymer, bottles, and preforms desirably have any one of these stated ranges in combination with the b* ranges described above, such as a b* range of −5 to +5 and an a* ranging from −4 to 2, or a b* ranging from above −2 to 4 or 0 to 4 and an a* ranging from −3 to 2.

In a preferred embodiment, the reheat agent particles will decrease the b* coordinate value of the polyester polymer, preform, or bottle. The b* coordinate value of the polyester polymer, preform, or bottle may decrease (move in a direction more towards blue) by at least 1 unit, or at least 2 units, or at least 3 units, or at least 5 units, or at least 8 units, or at least 10 units by the addition of the reheat agent particles, relative to the same composition without said reheat agent particles.

In another aspect of the invention, the b* coordinate value of the polyester polymer composition particles, preforms, or bottles, is less than 0.0, or less than −1.0 (less than being in a bluer direction, or less than −3.0, or less than −5.0, or less than −6.0, or less than −7.0, or less than −8.0, or less than −9.0, all the way down to −20, or down to −15, if measured in the absence of the yellow colorant in the polyester polymer composition particles, preforms, or bottles.

The instrument used for measuring CIELAB color should have the capabilities of a HunterLab UltraScan XE, which is a diffuse/8° spectrophotometer. The scale employed is the CIELAB scale (L*, a*, b*) with D65 illuminant and 10° observer calculated according to guidelines of ASTM E 308. Preforms are tested in transmission mode whereby the preform is placed halfway between the sphere port and the detector port and is held in place in the instrument using a preform holder, available from HunterLab. The large-area view (1 inch diameter light beam) option is employed. Triplicate measurements are averaged, whereby the sample is rotated 90° around its center axis between each measurement.

The intrinsic viscosity (It.V.) values described throughout this description are set forth in dL/g unit and calculated according to ASTM D 4603, whereby the inherent viscosity (Ih.V.) is measured at 30° C. in 60/40 wt/wt phenol/tetrachloroethane at a concentration of 0.5 g/dL.

The following test for reheat improvement temperature (RIT) is used herein, in order to determine the reheat improvement of the compositions. Twenty-ounce bottle preforms (with an outer diameter of 0.846 inches and a sidewall cross-sectional thickness of 0.154 inches) are run through the oven bank of a Sidel SBO2/3 blow molding unit. The lamp settings for the Sidel blow molding unit are shown in Table 1. The preform heating time in the heaters is 38 seconds, and the power output to the quartz infrared heaters is set at 64%.

TABLE 1
Sidel SBO2/3 lamp settings.

Lamps ON = 1 OFF = 0

| | Lamp | | | |
|---|---|---|---|---|
| | power | | | |
| Heating | setting | | | |
| Zone | (%) | Heater 1 | Heater 2 | Heater 3 |
| Zone 8 | 0 | 0 | 0 | 0 |
| zone 7 | 0 | 0 | 0 | 0 |
| Zone 6 | 0 | 0 | 0 | 0 |
| Zone 5 | 90 | 1 | 0 | 1 |
| Zone 4 | 90 | 1 | 0 | 1 |
| Zone 3 | 90 | 1 | 0 | 1 |
| Zone 2 | 90 | 1 | 0 | 1 |
| Zone 1 | 90 | 1 | 1 | 1 |

In the test, a series of fifteen preforms is passed in front of the quartz infrared heaters and the average preform surface temperature of the middle five preforms is measured. All preforms are tested in a consistent manner. The preform reheat improvement temperature (RIT) is then calculated by comparing the difference in preform surface temperature of the target samples containing a reheat additive with that of the same polymer having no reheat additive. The higher the RIT value, the higher the reheat rate of the composition.

Thus, in various embodiments, the twenty-ounce bottle preform reheat improvement temperature of the polyester compositions according to the claimed invention containing the reheat agent particles, may be at least 0.1° C., or at least 1° C., or at least 2° C., or at least 3° C., or at least 4° C., or at least 5° C., or at least 6° C., and/or up to 32° C., or up to 20° C., or up to 15° C., or up to 11° C.

The polyester polymer particles preferably comprise at least 80 wt. % polyester polymer, or at least 85 wt %, or at least 90 wt %, or at least 95 wt %, or at least 98 wt. %, or at least 99 wt. %, or 100 wt. % polyester polymer relative to all other polymers (but not inorganic material or fibers or fillers) present in the particles.

As noted above, there is provided a process for increasing the yellowness of a polyester polymer, comprising adding:
a. reheat agent particles comprising titanium, alloys of titanium, titanium nitride, titanium boride, titanium carbide, or combinations thereof; and
b. a yellow colorant

to a melt phase polymerization process for manufacturing a polyester polymer.

Yellow colorants are colorants that are yellow to the eye. These colorants desirably absorb light in the visible light spectrum at wavelengths within the range of 400 nm to 470 nm. The λmax may fall inside or outside of this range, provided that the colorant absorbs light in this range. In one embodiment, the yellow colorant absorbs light within the range of 400 to 470 nm and the λmax of the yellow colorant falls outside of this range. In another embodiment, yellow colorant absorbs light within the range of 400 to 470 nm and the λmax of the yellow colorant is less than 400 nm. In another embodiment, the λmax of the yellow colorant is within a range of 400 to 470 nm, or from 420 to 460 nm. In another embodiment, the λmax of the yellow colorant is within a range of 400 to 470 nm, or from 420 to 460 nm, and the yellow colorant also absorbs uv light at less than 400 nm, or within the range of 330 nm to 400 nm.

The band width of the yellow colorant is not particularly limited. In one embodiment, the half band width is least 100 nm. A broad spectrum is desirable in applications where one desires to absorb some uv light below 400 nm, yet have a yellow hue to the colorant due to absorbing light in the yellow spectrum ranging from 400 nm to 470 nm. In another embodiment, the half band width is less than 100 nm, or 80 nm or less, or 60 nm or less, or 50 nm or less, or 40 nm or less.

The yellow colorant is desirably soluble in the polyester polymer at the levels used and in the polyester polymer to which they are added. Yellow colorants that are not soluble in the polyester polymer to which they are added tend to cause the formation of specks in the polymer, or render the polymer hazy or unclear. Thus, to provide for a high clarity polymer that is bright (L* of at least 65), with no visible speck formation, the yellow colorant is desirably soluble, meaning sufficiently soluble so as to avoid the formation of specks or haze caused by the colorant.

In another embodiment, the yellow colorant is reactive with the polyester polymer reactants or the polyester polymer or both. In yet a further embodiment, the yellow colorant is a yellow colorant, absorbs UV light, and is reactive.

As further described below, the polyester polymer may contain colorants other than the yellow colorant in addition to the yellow colorant, such as orange or red colorants.

The colorants may be added to a melt phase polymerization for making the polyester polymer, or added to a melt processing zone fed by polyester polymer particles for making articles or compounded or melt blended particles. In the melt phase polymerization the colorants can be added to the esterification zone, to the polycondensation zone, or to conduits between the reactor vessels. Whether the colorants are added to a melt phase polymerization process or to a melt processing zone fed by polyester polymer particles, in each case, the yellow colorant may be added as a solid concentrate, or in a liquid carrier (also known as a paste, solution, slurry, dispersion, or emulsion), or neat.

When the colorant is added to a polyester polymer in a liquid carrier, the carrier may be inert or reactive. If using a reactive carrier, it is preferable used to add colorant to a melt phase polymerization process rather than to a melt processing zone where transesterification reactions occur and break down the It.V. of the polymer without any ability to recover and build back up the molecular weight. Inert liquid carriers for the yellow colorant should be compatible with the polyester polymer. The colorant may be suspended (dispersion or emulsion) or dissolved in the liquid carrier.

Desirably, the liquid carrier is non-aqueous and soluble in the polyester polymer so as to achieve uniform distribution of the colorants throughout the polymer. The carrier desirably also has a boiling point greater than the temperature at which the polyester polymer is processed either in the melt phase polymerization, an extruder barrel, or the barrel of an injection molding machine. Suitable carriers include hydrocarbons, mono-hydroxyl functional compounds such as alcohols, esters, and combinations thereof. Suitable reactive carriers include polyfunctional hydroxyl compounds such as diols.

Specific examples of liquid carriers include the hydrocarbon oils and vegetable oils, or the refined versions thereof. Such carriers are available commercially from ColorMatrix as Clearslip™ and ColorMatrix LCPY-1: 82-89 Series. Examples of diols as reactive carriers include ethylene glycol and polyethylene glycols (PEG's) and cyclic anhydrides.

A solid concentrate containing the yellow colorant and/or any other colorant may also be used and has the advantage that the concentrate is highly compatible since the polymers are of the same type as the bulk polymer in the melt processing zone or in the melt phase polymerization zone. Suitable polymers for making solid concentrates include polyester polymers and polyamide polymers, preferably polyester polymers. Desirably, the It.V. of the polyester polymer in the solid concentrate is within ±0.10, or ±0.05, or ±0.03 It.V. of the polyester polymer being fed to the melt processing zone for making articles or particles. The amount of yellow colorant in a solid concentrate is at least 10 ppm, or at least 20 ppm, or at least 50 ppm, or at least 100 ppm, or at least 200 ppm, or at least 400 ppm, or at least 500 ppm, or at least 750 ppm, or at least 1000 ppm, or at least 2000 ppm, or at least 3000 ppm, or at least 5000 ppm, or at least 6000 ppm, or at least 8000 ppm, or at least 10,000 ppm, and up to about 30 wt. %, or up to about 20 wt. %, or up to 10 wt. %, or up to 5 wt. %, based on the weight of the concentrate.

The yellow colorant and/or other colorants employed are desirably heat stable in the polymerization or molding environment. The yellow colorants, or other colorants employed, may optionally be copolymerizable with the polyester polymer either in the melt phase polymerization for making the polyester polymer or in a melt processing zone fed by polyester polymers and a yellow colorant. They are preferably not extractable from the polymer during normal use and handling of the articles and desirably do not affect the physical properties (other than color) of the articles in which they appear.

Yellow colorants useful in this invention include C.I. Solvent Yellows 98, 103, 105, 113, 116, 133, 157, 162, 176, and 187; C.I. Disperse Yellows 49, 54, 64, 77, 88, 89, 93, 118, 160, 200, and 201; C.I. Pigment Yellows 1, 2, 3, 4, 5, 6, 7, 10, 11, 12, 13, 14, 15, 16, 17, 23, 24, 42, 55, 62, 63, 65, 73, 74, 75, 81, 83, 93, 94, 95, 97, 98, 108, 109, 110, 111, 113, 120, 127, 128, 129, 130, 133, 136, 138, 139, 147, 150, 151, 154, 155, 156, 168, 169, 174, 175, 180, 181, 190, 191, 194, 199, and C.I. Vat Yellows 1, 3, and 20. Natural colorants and other synthetic monomeric and polymeric colorants and organometallic compounds are useful, such as those containing moieties of or residues of mono or diazo compounds, isoindolinone compounds, anthraquinone compounds, benzimidazolone compounds, azo metal complexes, methine compounds, quinophthalones, and naphthalidimide compounds, especially the methine and anthraquinone dyes that are yellow.

Other yellow organic dyes and pigments include Naphthol Yellow S, Hansa Yellow (10G, 5G, GR, A, RN, R and G), yellow iron oxide, Chrome Yellow, Titan Yellow, Oil Yellow, Pigment Yellow L, Benzidine Yellow (G and GR), Permanent Yellow (NCG), Vulcan Fast Yellow (5G and R), Tartrazine Lake, Quinoline Yellow Lake, and Anthrazane Yellow BGL.

The molecular weight of the yellow colorant is not particularly limited. The molecular weight typically ranges from at least 200, or at least 300, or at least 400, or at least 500, or at least 600, and up to 40,000, or up to 20,000, or up to 15,000, or up to 10,000, or up to 7500, or up to 5000, or up to 1500, or up to 1200, or up to 1000. Examples of yellow colorants having a molecular weight within a range of 600 to 1000 include CI Pigment Yellow 16, 81, 93, 94, 95, 113, 124, 168, 169, and 180.

A reactive colorant has at least one polyester reactive group. A polyester reactive group is a functional group reactive with one or more of the monomers or reactants used to make a polyester polymer, or reactive with a polyester polymer itself, and is reactive under melt processing conditions used to make an article or under melt phase conditions for the manufacture of a polyester polymer. The colorants can be added to a melt processing zone for making the article and reacted with the polyester polymer in the melt processing zone, or added to a melt phase polymerization process for making the polyester polymer and reacted with the reaction mixture in the melt phase, to thereby reduce the extractability of the colorants from the polymer relative to the colorants that are substantially non-reactive. In this embodiment, the colorant is also preferably thermally stable during melt phase polymerization or in a melt processing zone for making an article.

Non-extractable yellow reactive colorants are described in U.S. Pat. Nos. 4,359,570, 4,617,373; 5,106,942; the entire disclosures of which are incorporated herein by reference.

One example of non-extractable yellow, orange, and red reactive colorants described in U.S. Pat. Nos. 4,617,373 and 5,106,942 has at least one methine moiety defined herein as the group:

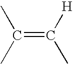

conjoined with a conjugated aromatic or heteroaromatic system. This moiety imparts the property of ultraviolet and/or visible light absorption, generally within the range of about 350-650 nanometers (nm). The position of the maximum of absorption is determined by the choice of substituents on the methine group. This structure class provides a very useful class of yellow dyes which absorbs strongly in the uv/visible part of the spectrum of wavelengths of the range 330 nm to 470 nm depending upon the substituents present on the chromophore. The methine compounds usually have a number average molecular weight of from about 200 to about 600, although lesser and higher molecular weights are useful. These yellow colorants have at least one polyester reactive group which will react with at least one of the functional groups from which the polyester is prepared into the polymer chain. Such polyester reactive groups are selected from hydroxyl, carboxy, amino C₁-C₆-alkoxycarbonyl, C₁-C₆-alkoxycarbonyloxy, and C₁-C₆-alkanoyloxy. These light-absorbing compounds are thermally stable at polymer processing temperatures up to about 300° C.

Preferred methine light absorbing compounds or monomers useful in the practice of the present invention have the general formulae:

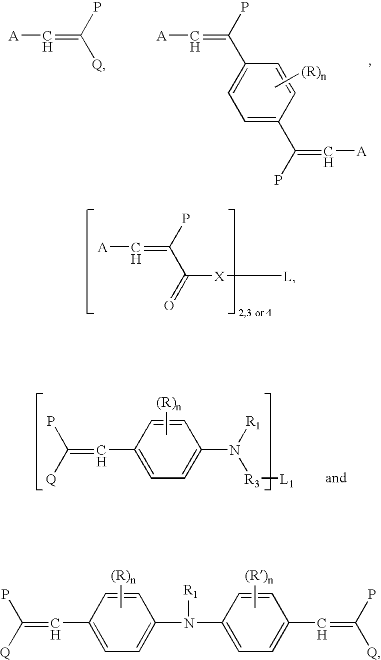

wherein:

A is conjugated with the attached double bond and is selected from the group of nitrogen containing moieties having the following formulae:

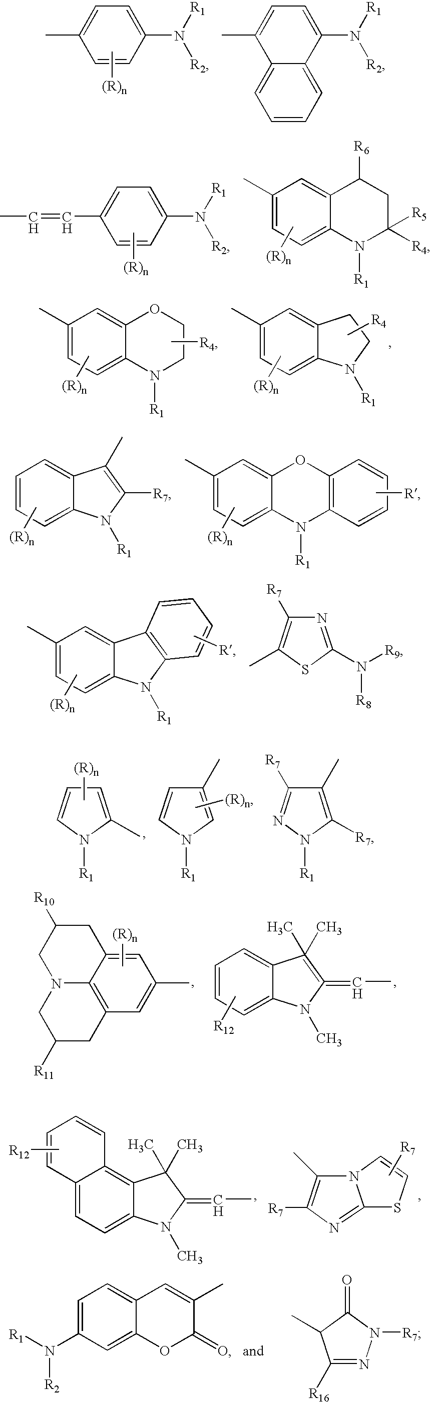

R and R′ are independently selected from hydrogen, C₁-C₆-alkyl, C₁-C₆-alkoxy and halogen;

n is 1 or 2;

R₁ is selected from C₃-C₈-cycloalkyl, C₃-C₈-alkenyl, aryl, C₁-C₁₂-alkyl, substituted C₁-C₁₂-alkyl, and —(CHR₁₃ CHR₁₄O)ₘ—R₁₅, wherein: m is an integer from 1 to about 500, preferably from 1 to about 100, more preferably from 1 to 8, and most preferably from 1 to 3; and

R₂ is selected from C₃-C₈-Cycloalkyl, C₃-C₈-alkenyl, aryl, C₁-C₁₂-alkyl, substituted C₁-C₁₂-alkyl, —(CHR₁₃ CHR₁₄O)ₘ—R₁₅, and an acyl group selected from —COR₁₆, —CO₂R₁₆, —CONHR₁₆— and —SO₂R₁₆, with the provision that when R₂ is an acyl group R₁ may be hydrogen; or

R₁ and R₂ can be combined with the nitrogen atom to which they are attached to make cyclic structures selected from pyrrolidino, piperidino, piperazino, morpholino, thiomorpholino, thiomorpholino-S,S-dioxide, succinimido, and phthalimido;

R₃ is selected from C₂-C₆-alkylene, and —(CHR₁₃CHR₁₄O)ₘ—CHR₁₃CHR₁₄—;

R₄, R₅ and R₆ are independently selected from hydrogen and C₁-C₆-alkyl;

R₇ is selected from hydrogen, C₁-C₆-alkyl and aryl;

R₈ and R₉ are independently selected from C₁-C₁₂-alkyl, substituted C₁-C₁₂-alkyl, aryl, C₃-C₈-cycloalkyl, and C₃-C₈-alkenyl or R₈ and R₉ can be combined with the nitrogen atom to which they are attached to produce cyclic structures such as pyrrolidino, piperidino and morpholino;

R₁₀ and R₁₁ are independently selected from hydrogen, halogen, C₁-C₆-akyl, hydroxyl and C₁-C₆-alkanoyloxy;

R₁₂ is carboxy, C₁-C₆-alkoxycarbonyl or (R)ₙ;

R₁₃ and R₁₄ are independently selected from hydrogen and C₁-C₆-alkyl;

R₁₅ is selected from hydrogen, aryl, C₁-C₁₂-alkyl, and C₁-C₆-alkanoyloxy;

R₁₆ is selected from C₁-C₆-alkyl, C₃-C₈-alkenyl, aryl, and C₃-C₈-cycloalkyl;

X is selected from —O—, —NH and —N(R₁₆)—;

L is a di, tri or tetravalent linking group;

L₁ is selected from a direct single bond or a divalent linking group;

P and Q are independently selected from cyano, —COR₁₆, —CO₂R₁₆, —CON(R₁₇)R₁₈, aryl, heteroaryl, and —SO₂R₁₆; or

P and Q can be combined with the conjugated double-bonded carbon atom to which they are attached to produce the following cyclic divalent radicals:

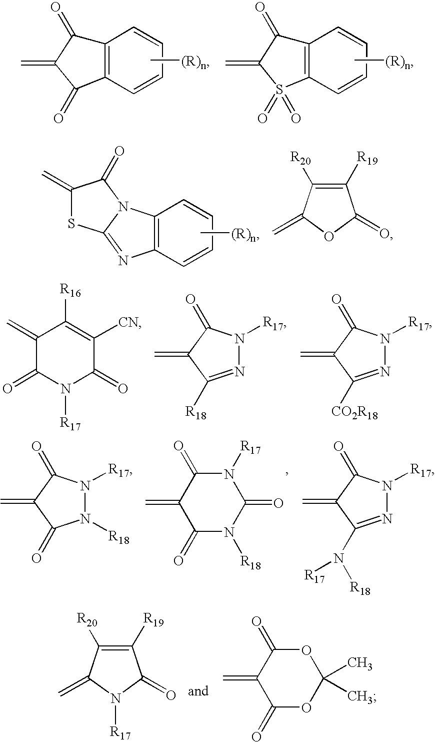

R₁₇ and R₁₈ are independently selected from hydrogen, C₁-C₆-alkyl, aryl C₃-C₈-cycloalkyl, and C₃-C₈-alkenyl;

R₁₉ is selected from cyano, carboxy, —CO₂R₁₆, —CON(R₁₇)R₁₈ and

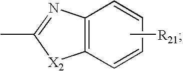

R₂₀ is selected from aryl and heteroaryl;

X₂ is selected from —O—, —S—, —N(R₁₇)—;

R₂₁ is selected from hydrogen, or up to two groups selected from C₁-C₆-alkyl, C₁-C₆-alkoxy, halogen, carboxy, cyano and —CO₂R₁₆; with the provision that Q may be hydrogen when P is selected from -carboxy, —CO₂R₁₆, —C(R₂₀)═C(CN)CN and

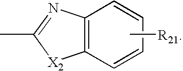

The methine compounds may have at least one reactive group selected from carboxy, —CO₂R₁₆, —OCOR₁₆, —OCON(R₁₇)R₁₈, —OCO₂R₁₆, hydroxyl and chlorocarbonyl, that is capable of reacting into the polyester composition during preparation or during melt phase processing to make an article.

In another embodiment, suitable yellow methine polymeric colorants have structures I (U.S. Pat. No. 5,254,625) and II (U.S. Pat. No. 5,532,332), both of which are fully incorporated herein by reference:

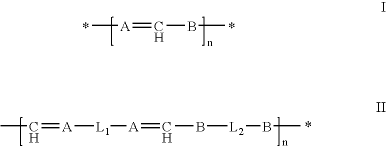

wherein:
A is selected from —O₂C—C(CN)═ and —(R₂₂)NOC—(CN)═;
B is selected from

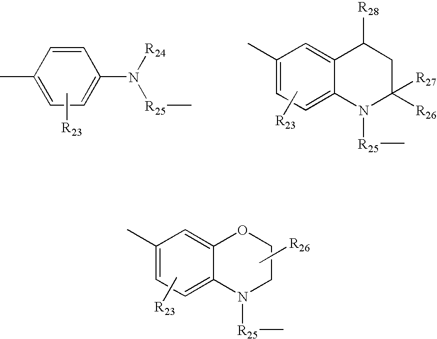

R₂₂ is selected from hydrogen, C₁-C₆ alkyl, substituted C₁-C₆ alkyl, C₃-C₆ cycloalky, aryl and heteroaryl;
R₂₃ is hydrogen or 1-2 substituents selected from C₁-C₆ alkyl, C₁-C₆ alkoxy, and halogen;
R₂₄ is selected from C₁-C₁₂ alkyl, substituted C₁-C₁₂ alkyl, C₃-C₈ cycloalkyl, C₃-C₈ alkenyl and aryl;
R₂₅ is selected from C₂-C₆ alkylene, —(CH₂CH₂O)₁₋₃—CH₂CH₂—, C₃-C₈ cycloalkylene, C₁-C₄ alkyene-phenylene-C₁-C₄ alkylene, and —CH₂-cyclohexylene-CH₂—;
R₂₆, R₂₇, R₂₈ are independently selected from hydrogen, and C₁-C₆ alkyl;
n is an integer from about 2 to about 40;

in structure II
=A-L₁-A= in combination may have the structure ═C(CN)-arylene-C(CN)═; —B-L₂-B— in combination may have the structure

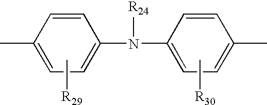

wherein R₂₄ is as defined above, and
R₂₉ and R₃₀₋ are independently selected from hydrogen, or 1-2 groups selected from C₁-C₆ alkyl, C₁-C₆ alkoxy, and halogen;
L₁ is selected from the divalent groups listed above for R₂₅;
L₂ is selected from a covalent bond, arylene, C₃-C₈ cycloalkylene, —O—, —S—, —SO₂—, —CO₂—. —OCO₂—, —CONH—, —O₂C—C₂C₆-alkylene-CO₂—, —O₂C-arylene-CO₂—, —O₂C—C₃-C₈-cycloakylene-CO₂—, —O₂CNH—C₄-C₁₀-alkylene-NHCO₂—, —O₂CNH—C₄-C₁₀-arylene-NHCO₂—, —(OCH₂CH₂)₁₋₃—OCH₂CH₂O—, and —O-arylene-O—;
n is an integer from 2 to about 40.

Yellow polymeric anthraquinone colorants (U.S. Pat. No. 6,197,223; Weaver, et al, “Coloration Technology”, 119, 48-56 (2003) which are suitable in the practice of the invention have structures III and IV:

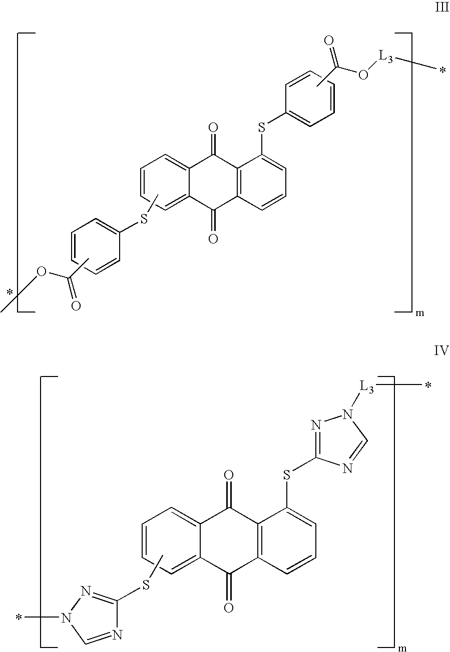

wherein:
L₃ is a divalent linking group selected from C₂-C₁₂ alkylene, —(CH₂CH₂O)₁₋₃—CH₂CH₂—, —CH₂—C₃-C₈ cycloalkylene-CH₂—, —CH₂-arylene-CH₂— and —CH₂CH₂—O-arylene-OCH₂CH₂—, and
m is at least 2.

Two of the preferred structures for III and IV are IIIa and IVa, respectively:

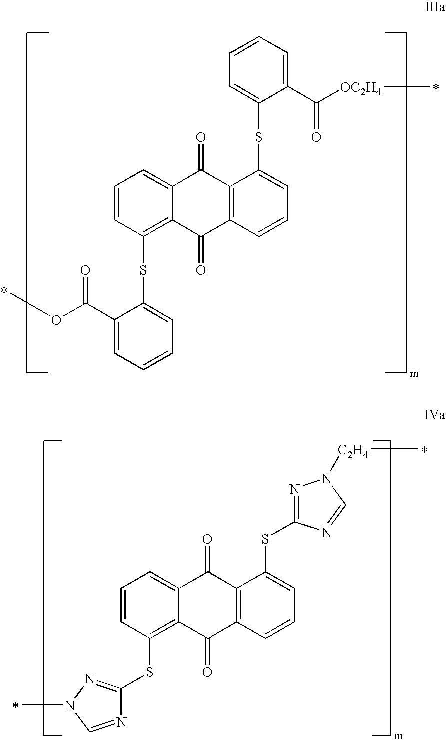

A “C₁-C₁₂-alkyl” may contain one to twelve carbon atoms and is either a straight or branched chain.

A “substituted C₁-C₁₂-alkyl” may be substituted with 1-3 groups selected from halogen, hydroxyl, cyano, carboxy, succinimido, phthalimido, 2-pyrrolidino, C₃-C₈-cycloalkyl, aryl, heteroaryl, vinylsulfonyl, phthalimidino, o-benzoic sulfimido, —OR₃₃, —SR₃₄, —SO₂R₃₅, —SO₂CH₂CO₂SR₃₄, —CON(R₃₆)R₃₇, —SO₂N(R₃₆)R₃₇, —O₂CN(R₃₆)R₃₇, —OCOR₃₅, —O₂CR₃₅, —OCO₂R₃₅, —OCR₃₅, —N(R₂₅)SO₂R₃₅, —N(R₂₅)COR₃₅,

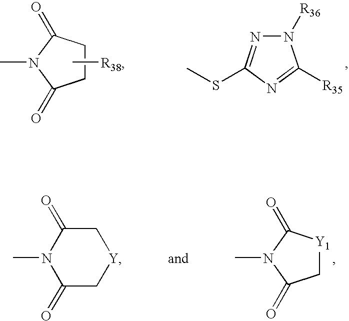

wherein:
R₃₃ is selected from C₁-C₆-alkyl, C₃-C₈-cycloalkyl; C₃-C₈-alkenyl and aryl;
R₃₄ is selected from C₁-C₆-alkyl, C₃-C₈-cycloalkyl, aryl and heteroaryl;
R₃₅ is selected from C₁-C₆-alkyl, C₃-C₈-cycloalkyl and aryl;
R₃₆ and R₃₇ are independently selected from hydrogen, C₁-C₆-alkyl, C₃-C₈-cycloalkyl and aryl;
R₃₈ is selected from hydroxy and C₁-C₆-alkanoyloxy;
Y is selected from —O—, —S—, and —N(R₃₅)—;
Y₁ is selected from C₂-C₄-alkylene, —O—, —S—, and —N(R₃₆)—.

A “C₁-C₆-alkyl” is a straight and branched chain hydrocarbon radicals, which may optionally be substituted with up to two groups selected from hydroxyl, halogen, carboxy, cyano, aryl, arylthio, arylsulfonyl, C₁-C₆-alkoxy, C₁-C₆-alkylthio, C₁-C₆-alkylsulfonyl, C₁-C₆-alkoxycarobonyl, C₁-C₆-alkoxycarbonyloxy, and C₁-C₆-alkanoyloxy.

A “C₁-C₆-alkoxy”, “C₁-C₆-alkylthio”, “C₁-C₆-alkylsulfonyl”, “C₁-C₆-alkoxycarbonyl”, “C₁-C₆-alkoxycarbonyloxy” and “C₁-C₆-alkanoyloxy” may have the following structures, respectively: —OC₁—C₆-akyl, —S—C₁-C₆-alkyl, —O₂S—C₁-C₆-alkyl, —CO₂-C₁-C₆-alkyl, —O₂C—O-C₁-C₆-alkyl, and —O₂C—C₁-C₆-alkyl, wherein the C₁-C₆-alkyl groups may optionally be substituted with up to two groups selected from hydroxy, cyano, halogen, aryl, —OC₁-C₄-alkyl, —OCOC₁-C₄-alkyl and CO₂C₁-C₄-alkyl, wherein the C₁-C₄-alkyl portion of the group represents saturated straight or branched chain hydrocarbon radicals that contain one to four carbon atoms.

A “C₃-C₈-cycloalkyl” and “C₃-C₈-alkenyl” includes a saturated cycloaliphatic radicals and straight or branched chain hydrocarbon radicals containing at least one carbon-carbon double bond, respectively, with each radical containing 3-8 carbon atoms.

The divalent linking groups for L can be selected from C₁-C₁₂-alkylene, —(CHR₁₃CHR₁₄O)ₘCHR₁₃CHR₁₄—, C₃-C₈-cycloalkylene, —CH₂—C₃-C₈-cycloalkylene —CH₂— and C₃-C₈-alkenylene. The C₁-C₁₂ alkylene linking groups may contain within their main chain heteroatoms, e.g. oxygen, sulfur and nitrogen and substituted nitrogen, (—N(R₁₇)—), wherein R₁₇ is as previously defined, and/or cyclic groups such as C₃-C₈-cycloalkylene, arylene, divalent heteroaromatic groups or ester groups such as:

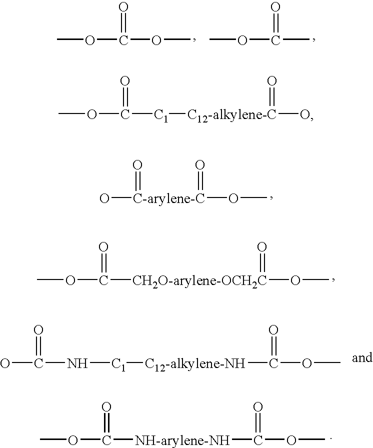

Some of the cyclic moieties which may be incorporated into the C₁-C₁₂-alkylene chain of atoms include:

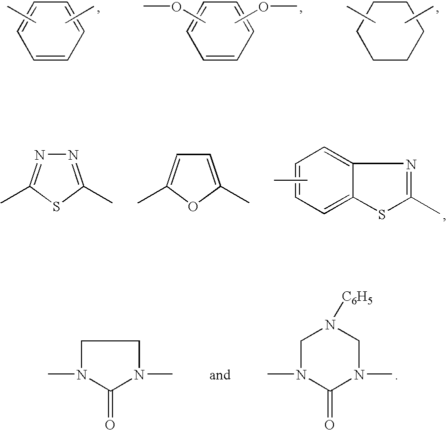

The trivalent and tetravalent radicals for L are selected from C₃-C₈-aliphatic hydrocarbon moieties which contain three or four covalent bonds.

Examples of trivalent and tetravalent radicals include —HC(CH₂—)₂ and C(CH₂—)₄, respectively.

The divalent linking groups for L₁ may be selected from —O—, —S—, —SO₂—, ═N—SO₂R₁, —S—S—, —CO₂—, —OCO₂—, arylene, —O-arylene-O—, C₃-C₈-cycloalkylene, —O₂C—C₁-C₁₂-alkylene-CO₂—, —O₂C-arylene-CO₂—, —O₂C—C₃C₈-cycloalkylene-CO₂—, —O₂CNH—C₁-C₁₂-alkylene-NHCO₂—, and —O₂CNH-arylene-NHCO₂—.

A “C₂-C₄-alkylene”, “C₁-C₆-alkylene” and “C₁-C₁₂-alkylene” includes a straight or branded chain divalent hydrocarbon radicals containing two to four, one to six and one to twelve carbon atoms, respectively, which may optionally may be substituted with up to two groups selected from hydroxyl, halogen, aryl and C₁-C₆-alkanoyloxy.

A “C₃-C₈-cycloalkylene” and C₃-C₈-alkylene” includes a divalent saturated cyclic hydrocarbon radicals which contain three to eight carbon atoms and divalent hydrocarbon radicals which contain at least one carbon-carbon double bond and have three to eight carbon atoms, respectively.

An “aryl” is a phenyl and phenyl substituted with one or more groups selected from C₁-C₆-alkyl, C₁-C₆-alkoxy, halogen, carboxy, hydroxyl, C₁-C₆-alkoxycarbonyl, C₁-C₆-alkylsulfonyl, C₁-C₆-alkythio, thiocyano, cyano, nitro and trifluoromethyl.

In the term “heteroaryl” the heteroaryl groups or heteroaryl portions of the groups are mono or bicyclo heteroaromatic radicals containing at least one heteroatom selected from the group consisting of oxygen, sulfur and nitrogen or a combination of these atoms in combination with carbon to complete through the heteroatomatic ring. Examples of suitable heteroaryl groups include but are not limited to: furyl, thienyl, thiazolyl, isothiazolyl, benzothiazolyl, pyrazolyl, pyrrolyl, thiadiazolyl, oxadiazolyl, benzoxazolyl, benzimidazolyl, pyridyl, pyrimidinyl and triazolyl and such groups optionally substituted with one or more groups selected from C₁-C₆-alkyl, C₁-C₆-alkoxy, aryl, C₁-C₆-alkoxy, carbonyl, halogen, arylthio, arylsulfonyl, C₁-C₆-alkylthio, C₁-C₆-alkylsulfonyl, cyano, trifluoromethyl, and nitro.

An “arylene” includes a 1,2-; 1,3-; 1,4-phenylene, naphthyl and those radicals optionally substituted with one or more groups selected from C₁-C₆-alkyl, C₁-C₆-alkoxy, halogen, carboxy, hydroxyl, C₁-C₆-alkoxycarbonyl, C₁-C₆-alkylsulfonyl, C₁-C₆-alkythio, thiocyano, cyano, nitro and trifluoromethyl.

The term halogen is used to denote fluorine, chlorine, bromine and iodine.

The alkoxylated moieties defined by the formulae: —(CHR₁₃CHR₁₄O)ₘ—R₁₅, and —(CHR₁₃CHR₁₄O)ₘ—CHR₁₃CHR₁₄—, have a chain length wherein m is from 1 to 500; preferably m is from 1 to about 100; more preferably m is less than 8, and most preferably m is from 1-3. In a preferred embodiment, the alkoxylated moieties are ethylene oxide residues, propylene oxide residues or residues of both.

The terms “pyrrolidino”, “piperidino”, “piperazino”, “morpholino”, “thiomorpholino” and “thiomorpholino-s,s-dioxide” are used herein to denote the following cyclic radicals, respectively:

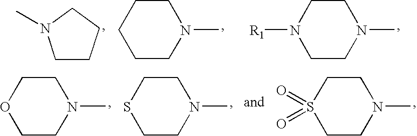

wherein R₁ is as defined above.

The skilled artisan will understand that each of the references herein to groups or moieties having a stated range of carbon atoms such as C₁-C₄-alkyl, C₁-C₆-alkyl, C₁-C₁₂-alkyl, C₃-C₈-cycloalkyl, C₃-C₈-alkenyl, C₁-C₁₂-alkylene, C₁-C₆-alkylene, includes moieties of all of the number of carbon atoms mentioned within the ranges. For example, the term “C₁-C₆-alkyl” includes not only the C₁ group (methyl) and C₆ group (hexyl) end points, but also each of the corresponding C₂, C₃, C₄, and C₅ groups including their isomers. In addition, it will be understood that each of the individual points within a stated range of carbon atoms may be further combined to describe subranges that are inherently within the stated overall range. For example, the term “C₃-C₈-cycloalkyl” includes not only the individual cyclic moieties C₃ through C₈, but also contemplates subranges such as C₄-C₆-cycloalkyl.

Specific examples of reactive methine group containing yellow colorants are:
1. methyl 3-[4-[[2-(acetyloxy)ethyl]ethylamino]-2-methylphenyl]-2-cyano-2-propenoate; and
2. methyl 3-[1-[2-(acetyloxy)ethyl]-1,2,3,4-tetrahydro-2,2,4,7-tetramethyl-6-quinolyl]-2-cyano-2-propenoate; and
3. bis[2-[[4(2-cyano-3-methoxy-3-oxy-1-propenyl)3-methylphenyl]ethylamino]ethyl]hexanedioate; and
4. methyl 2-[2-cyano-[4-[[2-acetyloxyethyl)ethyl]amino]-2-methylphenyl]ethylidene]-5-benzoxazole carboxylate; and
5. dimethyl 3,3′[(methylimino)di-4,1-phenylene]bis[2-cyano-2-propenoate]; and
6. those represented in Tables I-VIII:

TABLE I

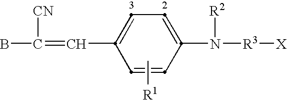

| Exam- | | | | |
|---|---|---|---|---|
| ple | B | R¹ | R² | —R³—X |
| 7 | —COOCH₃ | H | —C₆H₁₁ | —CH₂CH₂OOCCH₃ |
| 8 | —COOC₂H₅ | H | —CH₂C₆H₅ | —CH₂CH₂OOCCH₃ |
| 9 | —COO(CH₂)₄H | 2,5-di-OCH₃ | —C₂H₅ | —CH₂CH₂OOCCH₃ |
| 10 | —COOCH₂CH₂OH | 3-Cl | —CH₂CH═CH₂ | —(CH₂CH₂O)₂OCCH₃ |
| 11 | —COOCH₂CH₂CN | 3-Br | —(CH₂)₄H | —(CH₂CH₂O)₂H |
| 12 | —COOCH₂C₆H₅ | 2-OCH₃-5-CH₃ | —CH₂CH₂OC₂H₅ | —CH₂CH₂C₆H₄-4-COOH |
| 13 | —COOCH₂CH₂C₆H₅ | 2,5-di-CH₃ | —CH₂CH₂OC₆H₅ | —CH₂CH₂SCH₂CH₂OH |
| 14 | —COOCH₂CH₂C₆H₅ | 2-OCH₃-3-Cl | —CH₂CH₂Cl | —CH₂CH₂OC₆H₄-4-COOCH₃ |
| 15 | —COOCH₂CH₂Cl | H | —CH₂CH₂C₆H₅ | —CH₂CH₂SC₆H₄-4-COOCH₃ |
| 16 | —COOCH₂CH₂OC₂H₅ | 3-CH₃ | —C₆H₁₀-4-CH₃ | —CH₂CH₂N(SO₂CH₃)CH₂CH₂OH |
| 17 | 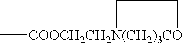 | 3-CH₃ | —CH₂C₆H₁₁ | —CH₂CH₂SO₂NHCH₂CH₂OH |
| 18 | —COOCH₂C₆H₁₁ | 3-CH₃ | —CH₂CH₂CN | —CH₂CH₂SO₂N(CH₃)CH₂CH₂OH |
| 19 | —COO(CH₂)₃CONH₂ | 3-CH₃ | —CH₂CH₂C₆H₁₁ | —CH₂CH₂SO₂NHC₆H₄-4-CH₂CH₂OH |
| 20 | —COOCH₂C(CH₃)₂CH₂OH | 3-CH₃ | —C₂H₅ | —CH₂C₆H₄-4-SO₂NHCH₂C(CH₃)₂CH₂OH |
| 21 | —COO(CH₂CH₂O)₂CH₃ | 3-CH₃ | —(CH₂)₃SO₂CH₃ | —CH₂CH₂OC₆H₄-4-SO₂NHCH₂CH₂OH |
| 22 | —COOCH₂CH(OH)CH₂Cl | 3-CH₃ | —CH₂CH₂CON(CH₃) | —CH₂CH₂SO₂C₆H₄-3-COOCH₃ |
| 23 | 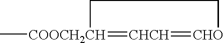 | 3-CH₃ | 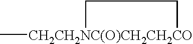 | —CH₂CH₂SC₆H₄-2-COOH |
| 24 | —COOCHC₆H₁₀-4-CH₂OH | 3-CH₃ | 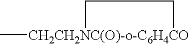 | —CH₂CH₂CONHC₆H₄-4-CH₂CH₂OH |
| 25 | 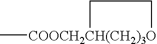 | 3-CH₃ | 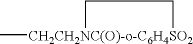 | —CH₂CH₂N(COC₆H₅)CH₂CHOH |
| 26 | —COOC₆H₄-4-OCH₃ | 3-CH₃ | 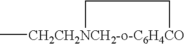 | —(CH₂)₃OH |
| 27 | 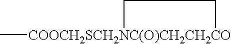 | 3-CH₃ | 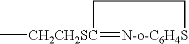 | —(CH₂)₄OOC₆H₅ |
| 28 | —COO(CH₂)₆OH | 3-CH₃ | —CH₂CH₂SO₂C₆H₅ | —(CH₂)₃OOCOC₂H₅ |
| 29 | —COO(CH₂)₄OH | 3-CH₃ | —CH₂CH₂Br | —CH₂CH₂CON(C₆H₅)CH₂CH₂OH |
| 30 | —COO(CH₂)₁₀OH | 3-CH₃ | —CH₂CHF₂ | —CH₂CH₂CONHCH₂C(CH₃)₂CH₂OH |
| 31 | —COOCH₂CHF₂ | H | —CH₂CH₂SC₂H₅ | —CH₂C₆H₁₀-4-CH₂OH |
| 32 | —COOC₆H₁₀-4-CH₃ | H | —CH₂CH₂OC₆H₁₁ | —CH₂C₆H₄-4-CH₂OH |
| 33 | —COOCH₂CH(CH₃)₂ | H | —CH₂CH(CH₃)₂ | —C₆H₄-4-COOH |
| 34 | —COOCH₃ | H | —CH₂C₆H₅ | CH₂C₆H₄-4-COOCH₃ |
| 35 | —COOCH₂CH(C₂H₅)(CH₂)₄H | H | —CH₃ | —C₆H₄-3-CH₂OH |
| 36 | —COOCH(CH₃)₂ | H | —C₂H₅ | —C₆H₄-4-CH₂CH₂OOCCH₃ |
| 37 | —COOCH₂CH₂OOCCH₃ | H | —C₆H₅ | —CH₂CH₂OOCNHC₆H₅ |
| 38 | —COOCH₂CH₂SCH₂CH₂OH | H | —C₆H₄-4-CH₃ | —CH₂CH₂CON(C₂H₅)₂ |
| 39 | —COOCH₂C₆H₅ | H | —C₆H₄-4-OCH₃ | —CH₂CH₂OOCNH(CH₂)₄H |
| 40 | —COOC₆H₁₀-4-OCH₃ | 3-OC₂H₅ | —C₆H₄-3-Cl | —(CH₂)₃COOC₂H₅ |
| 41 | —COOCH₂CH═CH₂ | 3-O(CH₂)₄H | —CH₂C₆H₄-2-Cl | —C₆H₄-4-OCH₂CH₂OH |
| 42 | —COOCH₂CH₂NHCOCH₃ | 3-O(CH₂)₃H | —C₆H₄-4-CN | —C₆H₄-3-SO₂NHCH₂CH₂OH |
| 43 | —COOCH₂CH₂NHCOC₆H₅ | 3-OC(CH₃)₃ | —C₆H₄-3-NO₂ | —C₆H₄-3-SO₂NHC₆H₄-4-COOCH₃ |
| 44 | —COOCH₂CH₂SC₆H₅ | 3-I | —C₆H₄-4-SO₂CH₃ | —CH₂C₆H₄-4OCH₂CH₂OH |
| 45 | —COO(CH₂)₃SO₂CH₃ | 2,5-di-Cl | —C₆H₄-4-NHCOC₆H₅ | —CH₂CH₂OOCC₆H₄-4-OCH₃ |
| 46 | —C₆H₄-4-COOH | H | —CH₂CH₂SO₂CH═CH₂ | —CH₂CH₂OOCC₆H₁₁ |
| 47 | —C₆H₄-4-COOCH₃ | H | —CH₂CH₂NHCOCH═CH₂ | —CH₂CH₂OOCOC₆H₅ |
| 48 | 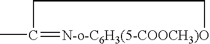 | 3-C₂H₅ | —CH₂CH₂OCH₂CH₂CN | —(CH₂)₃COOC₂H₅ |
| 49 | 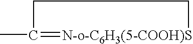 | -3-(CH₂)₄H | 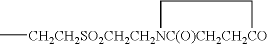 | 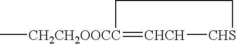 |
| 50 | 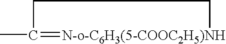 | H | 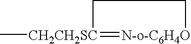 | 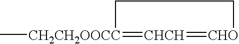 |
| 51 | 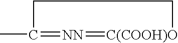 | H | 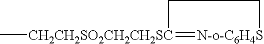 | —CH₂CH₂OOCC₆H₄-2-CH₃ |
| 52 | 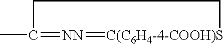 | H | 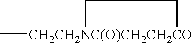 | —CH₂CH₂OOC₆H₄-3-Cl |
| 53 | 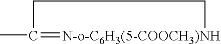 | H | 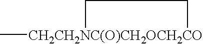 | —CH₂CH₂OOCC₆H₄-3-NO₂ |

TABLE II

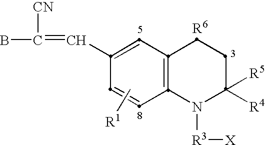

| Example | B | R¹, R⁴, R⁵, R⁶ | R³—X |
|---|---|---|---|
| 54 | —COOCH₃ | 2,2,4-tri-CH₃ | —CH₂CH₂OOCCH₃ |
| 55 | —COOC₂H₅ | 2,2,4,7-tetra-CH₃ | —CH₂CH,OH |
| 56 | —COOCH₃ | H | —CH₂CH₂OOCC₂H₅ |
| 57 | —COOCH₂CH(CH₃)₂ | H | —CH₂C₆H₄-4-COOH |
| 58 | —COOCH₂CH₂OCH₃ | 2-CH₃ | —CH₂C₆H₄-4-COOCH₃ |
| 59 | —COOCH₂CH₂OH | 2,7-di-CH₃ | —CH₂CH₂OH |
| 60 | —COOCH₂CH₂Cl | 7-CH₃ | —(CH₂)₃OOCCH₃ |
| 61 | —COOCH₂CH₂CN | 7-OCH₃ | —CH₂C₆H₄-4-COOH |
| 62 | —COOCH₂C₆H₅ | 7-Cl | —C₆H₁₀-4-OH |
| 63 | —COOCH₂CH₂OC₆H₅ | 7-Br | —C₆H₁₀-4-COOH |
| 64 | —COOC₆H₁₁ | 2-CH₃ | —CH₂CH₂OC₆H₄-4-COOH |
| 65 | —COOC₆H₅ | 2-CH₃ | —(CH₂CH₂O)₂H |
| 66 | —COOCH₂C₆H₁₁ | 2-C₂H₅ | —CH₂C₆H₄-3-SO₂NHCH₂CH₂OH |
| 67 | —COO(CH₂)₄OH | 2-(CH₂)₄H | —CH₂C₆H₁₀-4-CH₂OH |
| 68 | —COO(CH₂)₆OOCCH₃ | 2-CH₃ | —(CH₂)₄OOCCH₃ |
| 69 | —COOCH₃ | 2,5-di-CH₃-8-OCH₃ | —CH₂CH₂OOCCH₃ |
| 70 | —COOCH₃ | 2-CH₃-5,8-di-OCH₃ | —CH₂CH₂OH |
| 71 | —COOCH₃ | 2,2,4,5-tetra-CH₃-8-OCH₃ | —CH₂CH₂OOCOC₂H₅ |
| 72 | —COOCH₃ | 2,2,4-tri-CH₃-5,8-di-OC₂H₅ | —CH₂CH₂OONHC₆H₅ |
| 73 | —COOCH₃ | 2-CH₃-5-Cl-8-OCH₃ | —CH₂CH₂OOCNH₂ |
| 74 | —COOC₂H₅ | 2,2,4-tri-CH₃-7-OCH₃ | —CH₂CH₂COCN(CH₃)₂ |
| 75 | —COOC₂H₅ | 2,2,4-tri-CH₃-7-OC₂H₅ | —CH₃CH₂OOCC₆H₅ |
| 76 | —COOCH(CH₃)₂ | 2,2,4,8-tetra-CH₃-7-Cl | —CH₂CH₂OOCC₆H₁₁ |
| 77 | —COOCH₃ | 2,2,4,7-tetra-CH₃ | —CH₂C₆H₄-4-COOCH₃ |
| 78 | —COOCH₃ | 7-O(CH₂)₄H | —CH₂CH₂COOC₂H₅ |
| 79 | —COOCH₃ | 7-CH₃ | —CH₂C₆H₄-4-CH₂OH |
| 80 | —COOCH₃ | 2-CH₃-8-OCH₃ | 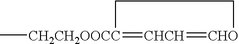 |
| 81 | 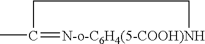 | 7-CH₃ | —CH₂CH₂OH |
| 82 | —COOCH₃ | 2,2,4-tri-CH₂-8-OC₂H₅ | 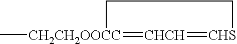 |
| 83 | 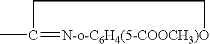 | 8-OC₂H₅ | —CH₂CH₂OH |

TABLE III

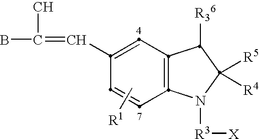

| Example | B | R¹, R⁴, R⁵, R⁶ | R³—X |
|---|---|---|---|
| 84 | —COOCH₃ | 2-CH₃ | —CH₂CH₂OH |
| 85 | —COOCH₃ | H | —CH₂CH₂OOCCH₃ |
| 86 | —COOCH₃ | 2,2,3-tri-CH₃ | —CH₂CH₂OOCOCH₃ |
| 87 | —COOC₂H₅ | 2,6-di-CH₃ | —CH₂CH₂OOCC₆H₅ |
| 88 | —COO(CH₂)₄H | 2,2,3-tri-CH₃-7-OCH₃ | —(CH₂CH₂O)₂H |
| 89 | —COOCH₂CH₂OH | 2,4,7-tri-CH₃ | —CH₂C₆H₄-4-COOCH₃ |
| 90 | —COOCH₂CH₂OC₂H₅ | 2,4-di-CH₃-7-OCH₃ | —CH₂CH₂OC₆H₄-2-COOH |
| 91 | —COOCH₂C₆H₅ | —2-CH₃-4,7-di-OC₂H₅ | —CH₂CH₂SC₆H₄-2-COOCH₃ |
| 92 | 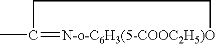 | 2-CH₃ | —(CH₂)₄OH |
| 93 | 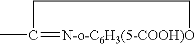 | 2,2,3-tri-CH₃ | —CH₂CH₂SO₂C₆H₄-3-COOCH₃ |
| 94 | 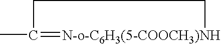 | 2,2,3-tri-CH₃ | —CH₂CH₂N(SO₂CH₃)CH₂CH₂OH |
| 95 | 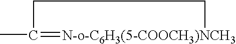 | 2,3-di-CH₃ | —CH₂CH₂SO₂NH(CH₂)₄OH |
| 96 | 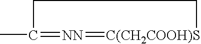 | 2-CH₃ | —CH₂CH₂N(SO₂CH₃)CH₂CH₂OH |
| 97 | 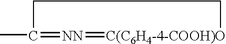 | 2-CH₃ | —CH₂CH₂CONHCH₂CH₂OH |
| 98 | 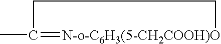 | 2-CH₃ | —CH₂C₆H₄-3-SO₂NHCH₂CH₂OH |

TABLE IV

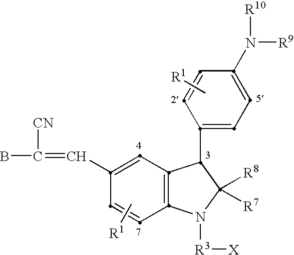

| Example | B | R¹ | R³—X | R⁷, R⁸ | R⁹ | R¹⁰ |
|---|---|---|---|---|---|---|
| 99 | —COOCH₃ | H | —CH₂CH₂OOCCH₃ | di-CH₃ | —CH | —CH₃ |
| 100 | —COOCH₃ | 2,6-di- | CH₂CH₂OH | di-CH₃ | —C₂H₅ | —C₂H₅ |
| | | CH₃ | | | | |
| 101 | —COOCH₃ | 2′,3′,6,7- | —CH₂CH₂OOCOC₂H₅ | —CH₃, —C₂H₅ | —CH₂C₆H₅ | —CH₂C₆H₅ |
| | | tetra- | | | | |
| | | CH₃ | | | | |
| 102 | —COOCH₃ | 3′,7-di- | —CH₂C₆H₄-4-COOCH₃ | —CH₃, —C₆H₅ | —CH₂CH₂OC₂H₅ | —CH₂CH₂OC₂H₅ |
| | | OCH₃ | | | | |
| 103 | —COOCH₃ | 6-Cl | —CH₂C₆H₄-4-COOH | —CH₃, | —C₂H₅ | —CH₂CH₂CN |
| | | | | —C₆H₄-4-CH₃ | | |
| 104 | —COOCH₃ | H | —CH₂CH₂OC₆H₄-2-COOH | —CH₃, | C₂H₅ | —CH₂CH₂Cl |
| | | | | —C₆H₄-4- | | |
| | | | | OCH₃ | | |
| 105 | —COOCH | H | —(CH₂CH₂O)₂H | —CH₃, | —C₆H₅ | —CH₃ |
| | | | | —C₆H₄-3-Cl | | |
| 106 | —COOCH₃ | H | —CH₂C₆H₄-3-SO₂NHC₆H₄-3-COOCH₃ | —CH₃, | —C₆H₁₁ | —CH₃ |
| | | | | —CH(CH₃)₂ | | |
| 107 | —COOC₂H₅ | H | —CH₂CH₂CONH(CH₂)₄OH | di-C₂H₅ | —C₆H₄-2-CH₃ | —C₂H₅ |
| 108 | —COO(CH₂)₄H | H | —CH₂CH₂N(SO₂CH₃)CH₂CH₂OH | di-CH₃ | —C₆H₄-3-OCH₃ | —CH₂CH₂C₆H₅ |
| 109 | —COOCH₂CH₂OH | H | —CH₂CH₂COOC₂H₅ | di-CH₃ | —C₆H₄-4-Cl | —CH₂C₆H₅ |

TABLE V

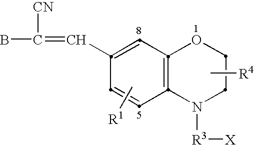

| Example | B | R¹, R⁴ | R³—X |
|---|---|---|---|
| 110 | —COOCH₃ | H | —CH₂CH₂OH |
| 111 | —COOCH₃ | 3-CH₃ | —CH₂CH₂OOCCH₃ |
| 112 | —COOC₂H₅ | 3,6-di-CH₃ | —CH₂CH₂OOCC₂H₅ |
| 113 | —COOCH₃ | 6-Cl | —(CH₂CH₂O)₂H |
| 114 | —COOCH₃ | 3,5,8-tri-CH₃ | —CH₂CH₂OOCC₆H₅ |
| 115 | —COO(CH₂)₄H | 2-CH₃-6-OCH₃ | —CH₂C₆H₄-4-COOH |
| 116 | —COOCH₂C₆H₅ | 2,3-di-CH₃ | —CH₂C₆H₄-3-COOH |
| 117 | —COOCH₃ | 3-CH₃ | —CH₂C₆H₄-4-COOCH₃ |
| 118 | 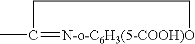 | 3-CH₃ | —CH₂CH₂OH |
| 119 | 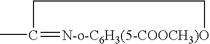 | 3-CH₃ | —CH₂CH₂OC₆H₄-3-COOH |
| 120 | —C═N-o-C₆H₃(5-COOH)NH | 3-CH₃ | —CH₂C₆H₄-3-SO₂NHC₆H₄-4-CH₂CH₂OH |
| 121 | 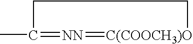 | 3-CH₃ | —CH₂CH₂SO₂C₆H₄-3-SO₂NHC₆H₄-3-CH₂OH |
| 122 | 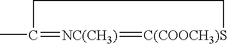 | 3-CH₃ | —CH₂CH₂SC₆H₄-4-SO₂NH(CH₂)₄OH |

TABLE VI

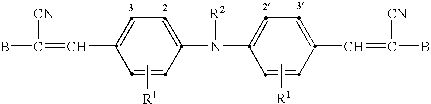

| Example | B | R¹ | R² |
|---|---|---|---|
| 123 | —COOCH₃ | H | —C₂H₅ |
| 124 | —COOCH₃ | 3-CH₃ | —CH₃ |
| 125 | —COOC₂H₅ | 3-OCH₃ | —CH₂C₆H₅ |
| 126 | —COOCH₂CH₂OH | 3-Cl-3′-CH₃ | —C₆H₄-4-Cl |
| 127 | —COOCH₂CH₂CN | 2,5,3′-tri-OCH₃ | —C₆H₁₁ |
| 128 | —COOCH₂CH₂OOCCH₃ | 3,3′-di-CH₃ | —CH₂C₄H₁₁ |
| 129 | —COOCH₂CH₂Cl | 2-C₂H₅ | 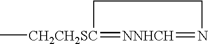 |
| 130 | —COOCH₂C₆H₅ | H | 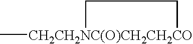 |
| 131 | —COOCH₂C₆H₁₁ | H | 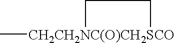 |
| 132 | —COOCH₂CH₂OC₆H₅ | H | 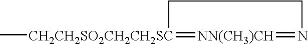 |
| 133 | —COOCH₂CH₂SCH₂CH₂OH | H | —CH₂CH₂SC₆H₅ |
| 134 | —COOCH₂CH₂NHCOCH₃ | H | —CH₂CH₂SC₆H₁₁ |
| 135 | 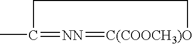 | H | 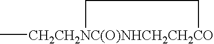 |
| 136 | 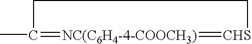 | H | 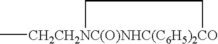 |
| 137 | H 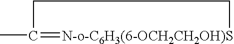 | H | 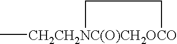 |

TABLE VII

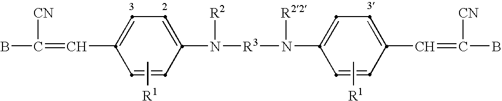

| Example | B | R¹ | R² | R^{2′} | R³ |
|---|---|---|---|---|---|
| 138 | —COOCH₃ | H | —C₂H₅ | —C₂H₅ | —CH₂CH₂— |
| 139 | —COOCH₃ | 3,3′-di-CH₃ | —CH₃ | —CH₃ | —CH₂CH₂OCH₂CH₂— |
| 140 | —COOCH₃ | 3,3′-di-OCH₃ | —C₆H₁₁ | —C₆H₁₁ | —CH₂CH₂OOCCH₂CH₂COOCH₂CH₂— |
| 141 | —COOC₂H₅ | 3-CH₃ | —C₂H₅ | —CH₃ | —CH₂CH₂OOCCH₂CH₂— |
| 142 | —COOCH(CH₃)₂ | 2,2′5,5′-tetra- | —C₂H₅ | —C₂H₅ | —CH₂C₆H₁₀-4-CH₂— |
| | | OCH₃ | | | |
| 143 | —COOC(CH₃)₃ | 3,3′-di-CH₃ | —CH₂CH₂OC₂H₅ | —CH₂CH₂OC₂H₅ | —CH₂C₆H₄-4-CH₂— |
| 144 | —COOCH₂CH₂OH | 3-CH₃ | —CH₂C₆H₅ | —C₆H₁₁ | —CH₂CH₂N(SO₂CH₃)CH₂CH₂— |
| 145 | —COOCH₂CH₂OCH₃ | 3,3′-di-CH₃ | —C₂H₅ | —C₂H₅ | —CH₂CH₂OC₆H₄-4-OCH₂CH₂— |
| 146 | —COOCH₂CH₂CN | 3,3′-di-CH₃ | —CH₂C₆H₁₁ | —CH₂C₆H₁₁ | —CH₂CH₂OOCOCH₂CH₂— |
| 147 | —COOCH₂CH₂Cl | H | —CH₂CH₂Cl | —CH₂CH₂Cl | —CH₂CH₂S—CH₂CH₂— |
| 148 | —COOCH₂C₆H₅ | H | —CH₂CH₂OC₆H₅ | —CH₂CH₂OC₆H₅ | —CH₂CH₂N(CH₃)CH₂CH₂— |
| 149 | —COOCH₂C₆H₁₁ | H | —CH₂CH₂CN | —CH₂CH₂CN | —CH₂CH₂OOCNH(CH₂)₆NHCOOCH₂CH₂— |
| 150 | —COOCH₂CH═CH₂ | H | —(CH₂)₃SO₂CH₃ | —(CH₂)₃SO₂CH₃ | —CH₂CH₂OOCNHC₆H₄-3-NHCOOCH₂CH₂— |
| 151 | —COOCH₃ | H | —CH₂CH═CH₂ | —CH₂CH═CH₂ | —CH₂CH₂OOCC₆H₄-4-COOCH₂CH₂— |
| 152 | 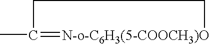 | H | —C₆H₅ | —CH₃ | —CH₂CH₂N(SO₂C₆H₅)CH₂CH₂— |
| 153 | 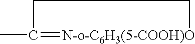 | H | —C₂H₅ | —C₂H₅ | —CH₂CH₂SO₂CH₂CH₂ |
| 154 | 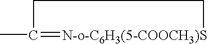 | 3,3′-di-CH₃ | —(CH₂)₄H | —(CH₂)₄H | -1,4-C₆H₄— |

TABLE VIII

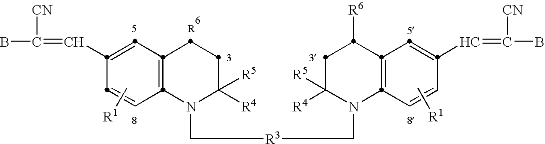

| Example | B | R¹, R⁴, R⁵, R⁶ | R³ |
|---|---|---|---|
| 155 | —COOCH₃ | H | —(CH₂)₄— |
| 156 | —COOCH₃ | 2,2′-di-CH₃ | —CH₂CH₂OOC(CH₂)₄COOCH₂CH₂— |
| 157 | —COOCH₃ | 7,7′-di-CH₃ | —CH₂CH₂SO₂CH₂CH₂ |
| 158 | —COOCH₃ | 7,7′-di-OCH₃ | —CH₂C₆H₄-4-CH₂— |
| 159 | —COOC₂H₅ | 2,2,2′,2′,4,4′-hexa-CH₃ | —CH₂CH₂OOCCH₂CH₂COOCH₂CH₂— |
| 160 | —COOCH₂CH(CH₃)₂ | 2,2,2′,2′,4,4′-hexa-CH₃ | —CH₂CH₂SCH₂CH₂— |
| 161 | —COOCH₃ | 2,2,2′,2′,4,4′,7,7′-octa-CH₃ | —CH₂C₆H₁₀-4-CH₂— |
| 162 | —COOCH₃ | 2,2′,7,7′-tetra-CH₃ | —CH₂CH₂SO₂CH₂CH₂— |
| 163 | —COOC₆H₅ | 7,7′-di-Cl | —CH₂CH₂OC₆H₄-4-OCH₂CH₂— |
| 164 | —COOCH₃ | 5,5′-di-CH₃-8,8′-di-OCH₃ | —CH₂CH₂N(SO₂CH₃)CH₂CH₂— |
| 165 | —COOCH₃ | 2,2′,7,7′-tetra-CH₃ | —CH₂CH₂OOCC₆H₄-3-COOCH₂CH₂— |
| 166 | —COOCH₃ | H | —CH₂CH₂OOCNC₆H₃-4-CH₃-3-NHCOOCH₂CH₂— |
| 167 | 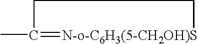 | 2,2′-di-CH₃ | —CH₂CH₂OOCC₆H₁₀-4-COOCH₂CH₂— |
| 168 | 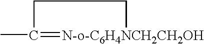 | 2,2′-di-CH₃ | —CH₂CH₂SO₂N(CH₃)CH₂CH₂— |
| 169 | 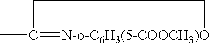 | 2,2′,7,7′-tetra-CH₃ | —CH₂CH₂N(SO₂C₆H₅)CH₂CH₂— |

as well as
Example 170:
ethyl [[4-(dimethylamino)phenyl]methylene]propenedioate prepared by the reaction of 4-(dimethylamino)benzaldehyde with diethyl malonate in the presence of a base catalyst in toluene as exemplified in Example 2 of U.S. Pat. No. 4,617,373, which is a pale yellow dye absorbing UV light at λₘₐₓ.373 nm with a molar extinction coefficient of 33,000; and
Example 171: a yellow dye represented by the structure:

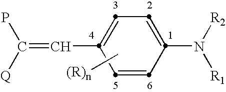

wherein (R)n represents a —CH₃ group at the 3 position; R₁ and R₂ are each

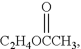

### P is CN, and Q is CO₂CH_{3.}

The dye of Example 171 can be prepared by the procedure used in Example 7 of U.S. Pat. No. 3,917,604.

Specific examples of yellow anthraquinone dyes include:

Example 172: 1,5-bis(2-carboxyphenylthio)anthraquinone, prepared as in

Example 1 of U.S. Pat. No. 4,359,570; and

Example 173: 1,5-bis[[1-(2-hydroxyethyl)-1,2,4-triazol-3-yl]thio]anthraquinone, prepared as in Example 18a of U.S. Pat. No. 6,727,372, and structures IIIa and Iva mentioned above.

In one aspect of the invention, there is provided a process for adding a yellow colorant to a melt phase polymerization process, or to the melt in a melt processing zone for making articles such as bottle preforms.

The amount of yellow colorant added is effective to produce a polyester polymer composition, preform, or bottle having a b* ranging from −5 to +5, or −4 or more, or −3 or more, or −2 or more, or −1 or more, and up to +5, or up to +4, or up to +3, or up to +2, or up to +1, and preferably between −1 and +2, or 0 and +1. The amount added desirably shifts the b* color of the polymer composition, preform, or bottle by at least 1 unit, or at least 2 units, or at least 3 units, or at least 4 units, or at least 5 units, on the b* color scale, relative to the same polymer, preform, or bottle, respectively, without the yellow colorant.

Suitable amounts of yellow colorant loading in the polymer vary widely depending on the molecular weight of the colorant, but generally not more than 100 ppm yellow colorant is required. In one aspect of the invention, the yellow colorant loading in the polyester polymer composition, particles, preforms, and/or bottles is typically 15 ppm or less, or 10 ppm or less, or 7 ppm or less, or 5 ppm or less, or 3 ppm or less, or 2 ppm or less, or 1 ppm or less, and greater than 0, based on the weight of the polyester polymer composition, particle, preform, and/or bottle.

In another embodiment of the invention, the polyester polymer composition contains orange and/or red colorants in addition to yellow colorants. The orange and/or red colorants may be added to a melt phase polymerization process or compounded with a polyester polymer in an extruder or added to an injection molding machine along with a polyester polymer for making a preform or other article.

Orange colorants are colorants that are orange to the eye. These colorants desirably absorb light in the visible light spectrum at wavelengths within the range of 475 nm to 490 nm. In one embodiment, the λmax falls within the range of 475 nm to 490 nm. The amount of orange colorant in the polymer is desirably 15 ppm or less, or 10 ppm or less, or 7 ppm or less, or 5 ppm or less, or 3 ppm or less, or 2 ppm or less, or 1 ppm or less, and greater than 0, based on the weight of the polyester polymer composition, particle, preform, and/or bottle. In another embodiment, the amount of orange colorant is effective to provide, together with the yellow colorant, a polyester polymer, preform, and/or bottle having a b* in the range of −2 to 4, and an a* in the range of −3 to 2

Examples of orange colorants for mixing with the yellow colorants as desired are: C. I. Solvent Oranges 60, 107, 109, 111, and 113; as well as C. I. Pigment Oranges 43 and 77. Useful thermally stable orange colorants which may be added during melt processing for copolymerization or by admixing into the polyester have structure V (U.S. Pat. No. 4,745,173, fully incorporated herein by reference);

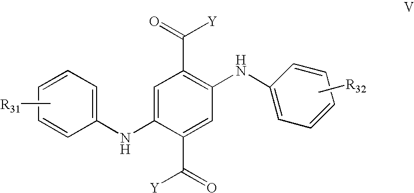

wherein
Y is selected from hydroxy, C₁-C₆ alkoxy, —OCH₂CH₂OH, —OCH₂CH(CH₃)OH and —(OCH₂CH₂)₁₋₃—OCH₂CH₂OH;
R₃₁ and R₃₂ are independently selected from hydrogen or 1-3 substituents selected from C₁-C₆ alkyl, C₁-C₆ alkoxy, halogen, cyclohexyl, —CH₂CH₂OH, —OCH₂CH₂OH, —CH(CH₃)OH and —CH₂OH.

Red colorants are colorants that are red to the eye. These colorants desirably absorb light in the visible light spectrum at wavelengths within the range of 490 to 530 nm. In one embodiment, the λmax falls within the range of 490 nm to 530 nm. The amount of red colorant in the polymer is desirably 15 ppm or less, or 10 ppm or less, or 7 ppm or less, or 5 ppm or less, or 3 ppm or less, or 2 ppm or less, or 1 ppm or less, and greater than 0, based on the weight of the polyester polymer composition, particle, preform, and/or bottle. In another embodiment, the amount of red colorant is effective to provide, together with the yellow colorant, a polyester polymer, preform, and/or bottle having a b* in the range of −2 to 4, and an a* in the range of −3 to 2.

Examples of red colorants for mixing with the yellow colorants to obtain the desired hue include C. I Solvent Reds 52, 135, 149, 151, 179, and 235; as well as C. I. Pigment Reds 149, 168, and 194. Useful thermally stable reactive colorants suitable for mixing with the yellow colorants and which are capable of being copolymerized when added during the melt phase polymerization process are disclosed in U.S. Pat. No. 5,372,864, fully incorporated herein by reference. Useful red anthraquinone colorants are described in structures II-VI in columns 3-6 and useful anthrapyridone colorants are described by structures VII-X in columns 5-8 of that patent. These red colorants are also useful for admixing with polyesters by compounding and melt blending or when added to a melt processing zone in the polyester preparation. Tables 2-10 of U.S. Pat. No. 5,372,864, fully incorporated herein by reference, disclose numerous specific examples of useful red colorants.

Thus, one may combine a yellow colorant with an orange colorant to obtain the desired hue. One may alternatively combine a yellow colorant with a red colorant to obtain the desired hue. Or, one many combine a yellow colorant, red colorant and an orange colorant. The particular combination of colorants and the amount of each added will depend on the desired color.

There is also provided another embodiment comprising a process for making a molded article comprising combining in a melt processing zone a yellow colorant composition and solid polyester polymer particles containing reheat agent particles comprising titanium, alloys of titanium, titanium nitride, titanium boride, titanium carbide, or combinations thereof to produce a colored molten composition, and molding the molten composition into an article, such as a preform, bottle, or other article. The article can be formed by extrusion, injection molding, or extrusion blow molding. Bottle preforms can be stretch blow molded into beverage containers, such as water, carbonated soft drink, or hot fill bottles.

As noted above, the colorant may be added to a melt phase polymerization process or to a melt processing zone fed by polyester polymer particles for making articles. The colorant may be fed in either case as a liquid or solid or a melt.

In a melt phase polymerization zone, polyester polymer compositions are made from reactants. The colorant may be added to the esterification zone, polycondensation zone (either to prepolymerization or to the finishing zone, or to conduits feeding any reactor or heat exchanger within the melt phase polymerization process. It may be injected neat, in a solution, dispersion, as a paste, or in a molten concentrate. It may be added to the melt phase polymerization process alone or together in combination with other additives, such as the catalyst, UV inhibitor, or reheat agents.

Suitable polymers made in the melt phase polymerization process are polyester polymers which are thermoplastic polymers. Thermoplastic polymers as used herein are distinguishable from thermotropic liquid crystals. Examples of suitable polyester polymers include one or more of: polyethylene terephthalate polymers (PET), polyethylene naphthalate polymers (PEN), poly(1,4-cyclo-hexylenedimethylene) terephthalate polymers and copolymers (PCT), poly(ethylene-co-1,4-cyclohexylenedimethylene terephthalate) polymers (PETG), copoly(1,4-cyclohexylene dimethylene/ethylene terephthalate) (PCTG), poly(1,4-cyclohexylene dimethylene terephthalate-co-isophthalate) (PCTA), poly(ethylene terephthalate-co-isophthalate) (PETA) and their blends, combinations thereof, or their copolymers. The form of a polyester composition is not limited, and includes a melt in the manufacturing process or in the molten state after polymerization, such as may be found in an injection molding machine, and in the form of a liquid, pellets, preforms, and/or bottles. Polyester particles may be isolated as a solid at 25° C. and 1 atm in order for ease of transport and processing. The shape of the polyester particles is not limited, and is typified by regular or irregular shaped discrete particles, but may be distinguished from a sheet, film, or fiber.

Examples of suitable polyesters include those described in U.S. Pat. No. 4,359,570, incorporated herein by reference in its entirety.

It should also be understood that as used herein, the term polyester is intended to include polyester derivatives, including, but not limited to, polyether esters, polyester amides, and polyetherester amides. Therefore, for simplicity, throughout the specification and claims, the terms polyester, polyether ester, polyester amide, and polyetherester amide may be used interchangeably and are typically referred to as polyester, but it is understood that the particular polyester species is dependant on the starting materials, i.e., polyester precursor reactants and/or components.

The melt phase polymerization process is useful to make polyester polymers, such as polyalkylene terephthalate or naphthalate polymers made by transesterifying a dialkyl terephthalate or dialkyl naphthalate or by directly esterifying terephthalic acid or naphthalene dicarboxylic acid. Thus, there are provided processes for making polyalkylene terephthalate or naphthalate polymer compositions by transesterifying a dialkyl terephthalate or naphthalate or directly esterifying a terephthalic acid or naphthalene dicarboxylic acid with a diol, and adding the described reheat agents and optionally the yellow colorant to the melt phase polymerization for the production of a polyalkylene terephthalate or naphthalate in the esterification zone, prepolymer zone, finishing zone, or to conduits between reactors in the melt phase polymerization process.

A preferred polyester polymer is a polyalkylene terephthalate polymer such as a polyethylene terephthalate polymer. As used herein, a polyalkylene terephthalate polymer or polyalkylene naphthalate polymer means a polymer having repeating alkylene terephthalate units or repeating alkylene naphthalate units in an amount of at least 60 mole %, or at least 70 mole %, or at least 80 mole %, or at least 90 mole %, based on the total moles of units in the polymer, respectively. Thus, the polymer may contain alkylene (e.g. ethylene) terephthalate or naphthalate units in an amount of at least 85 mole %, or at least 90 mole %, or at least 92 mole %, or at least 94 mole %, or at least 95 mole %, or at least 96 mole %, as measured by the mole % of ingredients in the finished polymer. Thus, a polyethylene terephthalate polymer may comprise a copolyester of ethylene terephthalate units and other units derived from an alkylene glycol or aryl glycol with an aliphatic or aryl dicarboxylic acid.

Polyethylene terephthalate can be manufactured by reacting a carboxylic acid component comprising a carboxylic acid or diester component comprising at least 60 mole % terephthalic acid or C₁-C₄ dialkylterephthalate, or at least 70 mole %, or at least 85 mole %, or at least 90 mole %, or at least 92 mole % or at least 94 mole % or at least 95 mole %, or at least 96 mole %, or at least 97 mole %, or at least 98 mole %, and a hydroxyl component comprising at least 60 mole % ethylene glycol, or at least 70 mole %, or at least 85 mole %, or at least 90 mole %, or at least 92 mole % or at least 94 mole % or at least 95 mole %, or at least 96 mole %, or at least 97 mole %, or at least 98 mole %. It is preferable that the carboxylic acid component is at least terephthalic acid and the hydroxyl component is at least ethylene glycol. The mole percentage for all the carboxylic acid component(s), preferably dicarboxylic acid components, totals 100 mole %, and the mole percentage for all the hydroxyl components, preferably the diol component(s), totals 100 mole %.

In another embodiment, the polyester polymer comprises residues of alkylene terephthalate or naphthalate residues, such as alkylene terephthalate residues (also known as repeating units) In another embodiment, the polyester polymer comprises residues of alkylene terephthalate or naphthalate residues, such as alkylene terephthalate residues, including ethylene terephthalate residues, each in an amount of at least 40 mole %, or at least 50 mole %, or at least 60 mole %, or at least 70 mole %, or at least 80 mole %, or at least 90 mole %, or at least 95 mole %, or at least 98 mole %.

In another embodiment, the polyester polymer comprises residues of alkylene terephthalate or naphthalate residues, such as alkylene terephthalate residues, including ethylene terephthalate residues, each in an amount of at least 40 mole %, or at least 50 mole %, or at least 60 mole %, or at least 70 mole %, or at least 80 mole %, or at least 90 mole %, or at least 95 mole %, or at least 98 mole %.

Examples of dicarboxylic acid units useful for the carboxylic acid component are units from phthalic acid, isophthalic acid, naphthalene-2,6-dicarboxylic acid, cyclohexanedicarboxylic acid, cyclohexanediacetic acid, diphenyl-4,4′-dicarboxylic acid, succinic acid, glutaric acid, adipic acid, azelaic acid, sebacic acid, and the like, with isophthalic acid, naphthalene-2,6-dicarboxylic acid, and cyclohexanedicarboxylic acid being preferable. It should be understood that use of the corresponding acid anhydrides, esters, and acid chlorides of these acids is included in the term “dicarboxylic acid” and all other carboxylic acid components.

In addition to units derived from ethylene glycol, the hydroxyl component of the present polyester may be modified with units from additional hydroxyl bearing compounds such as diols including cycloaliphatic diols preferably having 6 to 20 carbon atoms and aliphatic diols preferably having 2 to 20 carbon atoms. Examples of such diols include diethylene glycol (DEG); triethylene glycol; 1,4-cyclohexanedimethanol; 1,3-propanediol; 1,4-butanediol; 1,5-pentanediol; 1,6-hexanediol; 3-methyl-2,4-pentanediol; 2-methyl-1,4-pentanediol; 2,2,4-trimethyl-1,3-pentanediol; 2,2-diethyl-1,3-propanediol; 1,3-hexanediol; 1,4-di-(hydroxyethoxy)-benzene; 2,2-bis-4-hydroxycyclohexyl propane; 2,4-dihydroxy-1,1,3,3-tetramethylcyclobutane; 2,2-bis-3-hydroxyethoxyphenyl propane; and 2,2-bis-4-hydroxypropoxyphenyl propane.

The polyester compositions of the invention may be prepared by conventional polymerization procedures well-known in the art sufficient to effect esterification and polycondensation. Polyester melt phase polymerization manufacturing processes include direct condensation of a dicarboxylic acid with a diol optionally in the presence of esterification catalysts in the esterification zone, followed by polycondensation in the prepolymer and finishing zones in the presence of a polycondensation catalyst; or else ester interchange usually in the presence of a transesterification catalyst in the esterification zone, followed by prepolymerization and finishing in the presence of a polycondensation catalyst, and each may optionally be subsequently solid-stated according to known methods.

The polyester polymers obtained from the melt phase polymerization have an It.V. of at least 0.50 dL/g, or at least 0.60 dL/g, and preferably at least 0.70 dL/g, or at least 0.72 dL/g, or at least 0.74 dL/g, or at least 0.76 dL/g, or at least 0.78 dL/g, or at least 0.80 dL/g.

To further illustrate the process, a mixture of one or more dicarboxylic acids, preferably aromatic dicarboxylic acids, or ester forming derivatives thereof, and one or more diols, are continuously fed to an esterification reactor operated at a temperature of between 200° C. and 300° C., typically between 240° C. and 290° C., and at a pressure of 1 psig up to 70 psig. The residence time of the reactants typically ranges from between one and five hours. Normally, the dicarboxylic acid is directly esterified with diol(s) at elevated pressure and at a temperature of 240° C. to 270° C. The esterification reaction is continued until a degree of esterification of at least 60% is achieved, but more typically until a degree of esterification of at least 85% is achieved to make the desired monomer. The esterification reaction is typically uncatalyzed in the direct esterification process and catalyzed in transesterification processes. Polycondensation catalysts may optionally be added in the esterification zone along with esterification or transesterification catalysts.

Typical esterification/transesterification and polycondensation catalysts which may be used include the oxides, hydroxides, carboxylates, alkoxides or chelates of antimony, titanium, aluminum, cobalt, germanium, zinc, tin, magnesium, manganese, and alkali metals or alkaline earth metals. Preferred catalyst metals are titanium, aluminum, and alkali metals or alkaline earth metals and range from 2 ppm to 100 ppm cumulatively, or from 2 ppm to 50 ppm cumulatively, or from 2 ppm to 25 ppm cumulatively, or from 2 ppm to 50 ppm individually, or from 2 ppm to 25 ppm individually, or from 2 ppm to less than 15 ppm individually, or from 2 ppm to 13 ppm individually, in any combination.

The resulting products formed in the esterification zone include bis(2-hydroxyethyl)terephthalate (BHET) monomer, low molecular weight oligomers, DEG, and water as the condensation by-product, along with other trace impurities formed by the reaction of the catalyst and other compounds such as colorants or the phosphorus-containing compounds. The relative amounts of BHET and oligomeric species will vary depending on whether the process is a direct esterification process, in which case the amount of oligomeric species are significant and even present as the major species, or a transesterification process, in which case the relative quantity of BHET predominates over the oligomeric species. The water is removed as the esterification reaction proceeds and excess ethylene glycol is removed to provide favorable equilibrium conditions. The esterification zone typically produces the monomer and oligomer mixture, if any, continuously in a series of one or more reactors. Alternatively, the monomer and oligomer mixture could be produced in one or more batch reactors. It is understood, however, that in a process for making PEN, the reaction mixture will contain monomeric species such as bis(2-hydroxyethyl)naphthalate and its corresponding oligomers. Once the ester monomer is made to the desired degree of esterification, it is transported from the esterification reactors in the esterification zone to the polycondensation zone comprised of a prepolymer zone and a finishing zone.

Although reference is made to a prepolymer zone and a finishing zone, it is to be understood that each zone may comprise a series of one or more distinct reaction vessels operating at different conditions, or the zones may be combined into one reaction vessel using one or more sub-stages operating at different conditions in a single reactor. That is, the prepolymer stage can involve the use of one or more reactors operated continuously, one or more batch reactors or even one or more reaction steps or sub-stages performed in a single reactor vessel. In some reactor designs, the prepolymerization zone represents the first half of polycondensation in terms of reaction time, while the finishing zone represents the second half of polycondensation. While other reactor designs may adjust the residence time between the prepolymerization zone to the finishing zone at a 2:1 ratio, a common distinction in all designs between the prepolymerization zone and the finishing zone is that the latter zone operates at a higher temperature, lower pressure, and a higher surface renewal rate than the operating conditions in the prepolymerization zone. Generally, each of the prepolymerization and the finishing zones comprise one or a series of more than one reaction vessel, and the prepolymerization and finishing reactors are sequenced in a series as part of a continuous process for the manufacture of the polyester polymer.

Once an It.V. of typically no greater than 0.35 dL/g, or no greater than 0.40 dL/g, or no greater than 0.45 dL/g, is obtained, the prepolymer is fed from the prepolymer zone to a finishing zone where the second half of polycondensation is continued in one or more finishing vessels ramped up to higher temperatures than present in the prepolymerization zone, to a value within a range of from 280° C. to 305° C. until the It.V. of the melt is increased from the It.V of the melt in the prepolymerization zone (typically 0.30 dL/g but usually not more than 0.35 dL/g) to an It.V in the range of from at least 0.50 dL/g, or at least 0.60 dL/g, or at least 0.70 dL/g, or at least 0.72 dL/g, or at least 0.74 dL/g, or at least 0.76 dL/g, or at least 0.78 dL/g, or at least 0.80 dL/g. The final vessel, generally known in the industry as the “high polymerizer,” “finisher,” or “polycondenser,” is operated at a pressure lower than used in the prepolymerization zone, typically within a range of between 0.8 torr and 4.0 torr, or from 0.5 torr to 4.0 torr. Although the finishing zone typically involves the same basic chemistry as the prepolymer zone, the fact that the size of the molecules, and thus the viscosity, differs, means that the reaction conditions also differ. However, like the prepolymer reactor, each of the finishing vessel(s) is connected to a flash vessel and each is typically agitated to facilitate the removal of ethylene glycol.

The polyester polymer particles are preferably produced from the melt phase polymerization without further polymerization in the solid phase. Alternatively, they can be further polymerized in the solid-state.

There is provided a shipping container containing polyester polymer particles having an It.V. of at least 0.70, or at least 0.72, or at least 0.74, or at least 0.76, or at least 0.78, or at least 0.80 dL/g obtained from a melt phase polymerization and/or which have not been solid state polymerized. The shipping container is a container used to transport the polyester particles to a converter of the particles to make shaped articles. Examples of shipping containers include drums, totes, railcars, ship holds, and Gaylord boxes. These polyester polymer particles which have not been solid state polymerized are also fed to a melt processing zone to make shaped articles such as preforms, a suitable melt processing zone being an injection molding machine. The volume of the polyester particles within the shipping container may be at least 1 m³, or at least 5 m³, or at least 10 m³, or at least 15 m³.

The residence time in the polycondensation vessels and the feed rate of the ethylene glycol and terephthalic acid into the esterification zone in a continuous process is determined in part based on the target molecular weight of the polyethylene terephthalate polyester. Because the molecular weight can be readily determined based on the intrinsic viscosity of the polymer melt, the intrinsic viscosity of the polymer melt is generally used to determine polymerization conditions, such as temperature, pressure, the feed rate of the reactants, and the residence time within the polycondensation vessels.

Once the desired It.V. is obtained in the finisher, the melt is fed to a pelletization zone where it is filtered and extruded into the desired form. The polyester polymers of the present invention are filtered to remove particulates over a designated size, followed by extrusion in the melt phase polymerization to form polymer sheets, filaments, or pellets. Although this zone is termed a “pelletization zone”, it is understood that this zone is not limited to solidifying the melt into the shape of pellets, but includes solidification into any desired shape. Preferably, the polymer melt is extruded immediately after polycondensation. After extrusion, the polymers are quenched, preferably by spraying with water or immersing in a water trough, to promote solidification. The solidified condensation polymers are cut into any desired shape, including pellets.

Alternatively, once the polyester polymer is manufactured in the melt phase polymerization, it may be solidified. The method for solidifying the polyester polymer from the melt phase polymerization process is not limited. For example, molten polyester polymer from the melt phase polymerization may be directed through a die, or merely cut, or both directed through a die followed by cutting the molten polymer. A gear pump may be used as the motive force to drive the molten polyester polymer through the die. Instead of using a gear pump, the molten polyester polymer may be fed into a single or twin screw extruder and extruded through a die, optionally at a temperature of 190° C. or more at the extruder nozzle. Once through the die, the polyester polymer may be drawn into strands, contacted with a cool fluid, and cut into pellets, or the polymer may be pelletized at the die head, optionally underwater. The polyester polymer melt optionally filtered to remove particulates over a designated size before being cut. Any conventional hot pelletization or dicing method and apparatus can be used, including but not limited to dicing, strand pelletizing and strand (forced conveyance) pelletizing, pastillators, water ring pelletizers, hot face pelletizers, underwater pelletizers, and centrifuged pelletizers.

The polyester polymer of the invention may be partially crystallized to produce semi-crystalline particles. The method and apparatus used to crystallize the polyester polymer is not limited, and includes thermal crystallization in a gas or liquid. The crystallization may occur in a mechanically agitated vessel; a fluidized bed; a bed agitated by fluid movement; an un-agitated vessel or pipe; crystallized in a liquid medium above the glass transition temperature (T_{g}) of the polyester polymer, preferably at 140° C. to 190° C.; or any other means known in the art. Also, the polymer may be strain crystallized. The polymer may also be fed to a crystallizer at a polymer temperature below its T_{g} (from the glass), or it may be fed to a crystallizer at a polymer temperature above its T_{g}. For example, molten polymer from the melt phase polymerization reactor may be fed through a die plate and cut underwater, and then immediately fed to an underwater thermal crystallization reactor where the polymer is crystallized underwater. Alternatively, the molten polymer may be cut, allowed to cool to below its T_{g}, and then fed to an underwater thermal crystallization apparatus or any other suitable crystallization apparatus. Or, the molten polymer may be cut in any conventional manner, allowed to cool to below its T_{g}, optionally stored, and then crystallized. Optionally, the crystallized polyester may be solid stated according to known methods.

The particles desirably have a degree of crystallinity of at least 25%, or at least 30%, or at least 35%, or at least 40%, or at least 45%, and up to about 70%, or up to about 65%.

As known to those of ordinary skill in the art, the pellets formed from the condensation polymers, in some circumstances, may be subjected to a solid-stating zone wherein the solids are first crystallized followed by solid-state polymerization (SSP) to further increase the It.V. of the polyester composition solids from the It.V exiting the melt phase polymerization to the desired It.V. useful for the intended end use. Typically, the It.V. of solid stated polyester solids ranges from 0.70 dL/g to 1.15 dL/g. In a typical SSP process, the crystallized pellets are subjected to a countercurrent flow of nitrogen gas heated to 180° C. to 220° C., over a period of time as needed to increase the It.V. to the desired target.

Thereafter, polyester polymer solids, whether solid stated or not, are re-melted and re-extruded to form items such as containers (e.g., beverage bottles), filaments, films, or other applications. At this stage, the pellets are typically fed into an injection molding machine suitable for making preforms which are stretch blow molded into bottles.

If the reheat agent particles are added to the melt phase polymerization, it is desirable to use particles having a small enough particle size to pass through the filters in the melt phase polymerization, and in particular the pelletization zone. In this way, the particles will not clog up the filters as seen by an increase in gear pump pressure needed to drive the melt through the filters. However, if desired, the reheat agent particles can be added after the pelletization zone filter and before or to the extruder of the injection molding machine.

The reheat agent particles may also be added to post-consumer recycle (PCR) polymer. PCR containing reheat agent particles may be added to virgin bulk polymers by solid/solid blending or by feeding both solids to an extruder. Alternatively, PCR polymers containing the reheat agent particles are advantageously added to the melt phase polymerization for making virgin polymer between the prepolymerization zone and the finishing zone. The It.V. of the virgin melt phase polymerization after the prepolymerization zone is sufficiently high at that point to enable the PCR to be melt blended with the virgin melt. Alternatively, PCR may be added to the finisher. In either case, the PCR added to the virgin melt phase polymerization may contain the reheat agent particles. The reheat agent particles may be combined with PCR by any of the methods noted above, or separately fed to and melt blended in a heated vessel, followed by addition of the PCR melt containing the reheat agent particles to the virgin melt phase polymerization at these addition points.

Examples of other reheat rate enhancing additives that may be used in combination with reheat agent particles include carbon black, graphite, tungsten, molybdenum, antimony, tin, copper, silver, gold, palladium, platinum, black iron oxide, and the like, in the amounts and sizes described above with respect to the reheat agent particles of the invention, as well as near infrared absorbing dyes, including, but not limited to, those disclosed in U.S. Pat. No. 6,197,851, incorporated herein by reference.

The compositions of the present invention optionally may contain one or more additional UV-absorbing compounds. One example includes UV-absorbing compounds which are covalently bound to the polyester molecule as either a comonomer, a side group, or an end group. Suitable UV-absorbing compounds are thermally stable at polyester processing temperatures, absorb in the range of from 320 nm to 380 nm, and migrate minimally from the polymer. The UV-absorbing compounds preferably provide less than 20%, more preferably less than 10%, transmittance of UV light having a wavelength of 370 nm through a bottle wall or sample that is 0.012 inches thick. Suitable chemically reactive UV absorbing compounds may include, for example, substituted methine compounds.

Suitable compounds, their methods of manufacture and incorporation into polyesters include those disclosed in U.S. Pat. No. 4,617,374, the disclosure of which is incorporated herein by reference. Other suitable UV-absorbing materials include benzophenone, benzotriazole, triazine, benzoxazinone derivatives. These UV-absorbing compound(s) may be present in amounts between 1 ppm to 5,000 ppm by weight, preferably from 2 ppm to 1,500 ppm, and more preferably between 10 ppm and 1000 ppm by weight. Dimers of the UV absorbing compounds may also be used. Mixtures of two or more UV absorbing compounds may be used. Moreover, because the UV absorbing compounds are reacted with or copolymerized into the backbone of the polymer, the resulting polymers display improved processability including reduced loss of the UV absorbing compound due to plateout and/or volatilization and the like.

Hydrolytically sensitive UV absorbing compounds are preferably added, in direct esterification processes, after 50% conversion of reactants in an esterification zone, and more preferably after 95% conversion, or between esterification and polycondensation zones, or to a prepolymerization polycondensation zone. In this way, the yield (e.g. at least 40%) of the UV absorbing compound in the polyester polymer particles is increased, and the UV absorbing degradation products are reduced.

The polyester compositions of the present invention are suitable for forming a variety of shaped articles, including films, sheets, tubes, preforms, molded articles, containers and the like. Suitable processes for forming the articles are known and include extrusion, extrusion blow molding, melt casting, injection molding, stretch blow molding, thermoforming, and the like.

It is also possible to add certain diethylene glycol (DEG) inhibitors to reduce or prevent the formation of DEG in the final resin product. Preferably, a specific type of DEG inhibitor would comprise a sodium acetate-containing composition to reduce formation of DEG during the esterification and polycondensation of the applicable diol with the dicarboxylic acid or hydroxyalkyl, or hydroxyalkoxy substituted carboxylic acid. It is also possible to add stress crack inhibitors to improve stress crack resistance of bottles, or sheeting, produced from this resin.

Other components can be added to the polymer compositions of the present invention to enhance the performance properties of the polyester composition. For example, crystallization aids, impact modifiers, surface lubricants, denesting agents, stabilizers, antioxidants, ultraviolet light absorbing agents, catalyst deactivators, colorants, nucleating agents, acetaldehyde reducing compounds, other reheat enhancing aids, fillers, anti-abrasion additives, and the like can be included. The resin may also contain small amounts of branching agents such as trifunctional or tetrafunctional comonomers such as trimellitic anhydride, trimethylol propane, pyromellitic dianhydride, pentaerythritol, and other polyester forming polyacids or polyols generally known in the art. All of these additives and many others and their use are well known in the art. Any of these compounds can be used in the present composition.

As noted above, there is also provided a process for increasing the yellowness of an article, comprising adding to a melt processing zone for making said article a primary feed of polyester polymer particles and:
a) reheat agent particles comprising titanium, alloys of titanium, titanium nitride, titanium boride, titanium carbide, or combinations thereof, and
c) a yellow colorant.

The primary feed of polyester polymer particles means the feed of the bulk polyester particles. A secondary feed of polyester polymer particles means a feed of polyester particles in smaller quantities by weight than the bulk polyester particles. An example of a secondary feed of polyester particles includes a feed of concentrate containing additives such as reheat agents, colorants, or other additives which one may find desirable to let down into the primary feed of polyester particles in addition to the additives already contained in the polyester particles used in the primary feed. The primary feed of polyester polymer particles is not limited to the feed into the barrel of a melt processing zone. For example, a primary and secondary feed of polyester polymer particles may be dry blended and fed together as one stream into the barrel where the polymer is melted.

In one embodiment, the reheat agent particles are contained in the polyester polymer particles. In another embodiment, the yellow colorant and optional orange and/or red colorants are contained in the polyester polymer particles. In yet another embodiment, both the reheat agent particles and the yellow colorant and optional orange and/or red colorants are contained in the polyester polymer particles.

In yet a further embodiment, the polyester polymer particles fed to the melt processing zone contain no or less than the amount of either or both of the reheat agent particles or yellow colorant than present in the article. In this case, there is provided, a feed of reheat agent particles and a feed of polyester polymer particles to the melt processing zone. In another case, there is provided a feed of yellow colorant and polyester polymer particles to the melt processing zone. In yet another case, there is provided a feed of polyester polymer particles and separate or combined feeds of yellow colorant and reheat agent particles to the melt processing zone for making the article. If feeds of yellow colorant and/or reheat agent particles to the melt processing zone are required, these streams may be fed as described above, e.g. solid concentrates let down at a desired ratio, liquid feeds as solutions, dispersions, emulsions, or pastes, or neat. Orange and/or red colorants may be combined and added or employed along with the yellow colorant as an additive to the polyester polymer or within the polyester polymer particles.

In another embodiment of the invention, there is provided concentrate particles, said particles comprising a polyester polymer, a yellow colorant, and the reheat agent particles. The concentrate differs from the polyester polymer particles described above in that the concentrate has a high concentration of yellow colorant, reheat agent particles, or both. Thus, in one embodiment, the concentrate contains a yellow colorant and reheat agent particles each or individually in an amount of at least 10 ppm, or at least 20 ppm, or at least 50 ppm, or at least 100 ppm, or at least 500 ppm or at least 750 ppm, or at least 1000 ppm, or at least 2000 ppm, or at least 5000 ppm, or at least 7000 ppm, or at least 10,000 ppm, or at least 12,000 ppm, or at least 15,000 ppm, or at least 20,000 ppm, and up to about 30 wt. %, or up to 20 wt. %, or up to 10 wt. %, or up to 5 wt. %, based on the weight of the concentrate. The concentrate is a useful means for incorporating the yellow colorant and reheat agent particles into the melt processing zone for mixing with the molten polyester polymer particles in the melt processing zone when making an article. Desirably, the It.V. of the polyester polymer in the solid concentrate is within ±0.10, or ±0.05, or ±0.03 It.V. of the polyester polymer particles fed to the melt processing zone. Orange and/or red colorants may be combined and added or employed along with the yellow colorant as an additive to the polyester polymer or within the concentrate.

A variety of articles can be made from the polyester compositions of the invention, including those in which reheat is neither necessary nor desirable. Articles include sheet, film, bottle preforms, bottles, trays, other packaging, rods, tubes, lids, fibers and injection molded articles. Any type of bottle can be made from the polyester compositions of the invention. Thus, in one embodiment, there is provided a beverage bottle made from PET suitable for holding water, preferably still water (non-gased). In another embodiment, there is provided a heat-set beverage bottle suitable for holding beverages which are hot-filled into the bottle. In yet another embodiment, the bottle is suitable for holding carbonated soft drinks. Further, in yet another embodiment, the bottle is suitable for holding alcoholic beverages, such as beer.

In each of the embodiments of the invention, including process for making a polyester polymer, there is also provided the polyester polymer compositions, articles including the food and beverage containers, and bottle preforms, having the properties of the polyester polymer compositions described herein.

### EXAMPLES

### Example 1

In this example, the effect of addition of a yellow colorant to a PET polymerization process was evaluated. Two polymers were prepared. The control polymer contained titanium nitride reheat additive and red toner. The titanium nitride particles had a nominal average particle size of 20 nm and were purchased from Hefei Kiln. The red toner used was the anthraquinone colorant disclosed in Example 21 of U.S. Pat. No. 5,384,377: I,5-bis(5-(N-(2-hydroxyethyl)-N-ethylsulfamoyl)-2-methoxyanilino)anthraquinone. (CAS# 163485-98-1). The test polymer contained the same titanium nitride reheat additive, the same red toner and Yellow Colorant 1.

Yellow Colorant 1 has the structure:

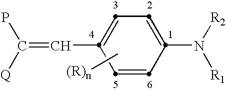

wherein (R)n represents a —CH₃ group at the 3 position; R₁ and R₂ are each

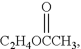

### P is CN, and Q is CO₂CH₃. (CAS# 53554-75-9).

The polymers were molded into discs with a diameter of 3 cm and a thickness of 0.17 cm using a Daca MicroCompounder/MicroInjector. A HunterLab Ultrascan spectrophotometer was used to measure L*, a* and b* on the discs. The CIELAB color was calculated using D65 illuminant and 10° observer. The color measurements were made in the total transmission (TTRAN) mode. Three discs were stacked together (0.51 cm total thickness) and placed in a holder at the sphere port. The results are given in Table 1 and demonstrate the effectiveness of adding a yellow colorant to increase the yellowness of polymers containing titanium nitride reheat additive. The b* was increased from 0.29 to 1.09 by the addition of 0.36 ppm Yellow Colorant 1

TABLE 1
Polymerizations Containing Yellow Colorant 1

| | ppm Ti | | | | | |
|---|---|---|---|---|---|---|
| | (as | ppm | ppm | | | |
| | titanium | red | Yellow | | | |
| Sample | nitride) | toner | Colorant 1 | L* | a* | b* |
| control | 7.5 | 1.2 | 0 | 69.93 | −0.63 | 0.29 |
| Test | 7.5 | 1.2 | 0.36 | 68.58 | −1.02 | 1.09 |

### Example 2

This example demonstrates the effectiveness of yellow colorants to decrease the blueness of a resin containing titanium nitride using a blending method. A PET concentrate was prepared from Yellow Colorant 1, Yellow Colorant 2, and Yellow Colorant 3. The structure of Yellow Colorant 1 is described above. Yellow Colorant 2 is ethyl [[4-(dimethylamino)phenyl]methylene]propenedioate (CAS# 3435-56-1). Yellow Colorant 3 is 1,5-bis(2-carboxyphenylthio)anthraquinone (CAS # 76404-13-2).

The PET resin used to prepare the yellow colorant concentrate was Eastman PET CM01, which is commercially available from Eastman Chemical Company. The concentrates were prepared by combining the yellow colorant with CM01 resin and then extruding the mixture at 275° C. on a Daca MicroCompounder. The extrudate was cryogenically ground in a Wiley Mill to form a coarse powder. The nominal amounts of yellow colorant in each of the concentrates were the following:

Concentrate 1: 0.0025 wt % Yellow Colorant 1

Concentrate 2: 0.025 wt % Yellow Colorant 2

Concentrate 3: 0.0025 wt % Yellow Colorant 3

The effect of each yellow colorant on PET resin color was determined by blending the concentrate with a production grade PET resin (“Resin A”) containing 6 ppm Ti as nanosized titanium nitride (20 nm nominal particle size) and 1.2 ppm red toner. The red toner used was the anthraquinone colorant disclosed in Example 21 of U.S. Pat. No. 5,384,377: I,5-bis(5-(N-(2-hydroxyethyl)-N-ethylsulfamoyl)-2-methoxyanilino)anthraquinone (CAS# 163485-98-1) The titanium nitride particles in Resin A functioned to increase the reheat rate of the polymer and also caused a blue color shift in the polymer. The yellow colorant concentrates were combined with coarse granules of Resin A and dried at 110° C. in a vacuum oven for 16 hours. The dried mixtures were then extruded at 275° C. in a Daca MicroCompounder. The extrudate was ground in a Wiley Mill to produce coarse granules. The granules were then dried at 110° C. in a vacuum oven for 16 hours and were then molded into discs with a diameter of 3 cm and a thickness of 0.17 cm using a Daca MicroCompounder/MicroInjector. A HunterLab Ultrascan spectrophotometer was used to measure L*, a* and b* on the disc. The CIELAB color was calculated using D65 illuminant and 10° observer. The color measurements were made in the total transmission (TTRAN) mode, in which both light transmitted directly through the sample and the light that is diffusely scattered was measured. A single disc was placed at the sphere port. The results are given in Table 2.

TABLE 2
Blending of Yellow Colorants in PET Resin

| | | | | disc |
|---|---|---|---|---|
| Entry | Sample Description | disc L* | disc a* | b* |
| 1 | Resin A (control) | 90.65 | −0.65 | −0.05 |
| 2 | Resin A + 0.2 ppm Yellow Colorant 1 | 90.58 | −0.70 | −0.10 |
| 3 | Resin A + 0.4 ppm Yellow Colorant 1 | 90.40 | −0.78 | 0.09 |
| 4 | Resin A + 0.8 ppm Yellow Colorant 1 | 90.42 | −0.87 | 0.36 |
| 5 | Resin A + 2.8 ppm Yellow Colorant 2 | 90.35 | −0.80 | 0.23 |
| 6 | Resin A + 5.6 ppm Yellow Colorant 2 | 90.66 | −0.93 | 0.42 |
| 7 | Resin A + 11.2 ppm Yellow Colorant 2 | 90.66 | −1.19 | 0.97 |
| 8 | Resin A + 0.6 ppm Yellow Colorant 3 | 90.47 | −0.67 | 0.03 |
| 9 | Resin A + 1.2 ppm Yellow Colorant 3 | 90.85 | −0.70 | 0.14 |
| 10 | Resin A + 2.4 ppm Yellow Colorant 3 | 90.72 | −0.73 | 0.45 |

The results in Table 2 show that each of the colorants is effective at decreasing the blueness of PET Resin A. Yellow Colorant 1 is the most efficient at decreasing blueness. Yellow Colorant 3 has the smallest impact on a* (i.e. less shift toward green or more negative a* value), and therefore may be preferred in certain formulations where less greenness is desired. Advantageously, all three yellow colorants caused no decrease in L* (i.e. brightness).

### Example 3

This example demonstrates the effectiveness of polymeric yellow colorants to decrease the blueness of a resin containing titanium nitride. Yellow Colorant 4 is a methine type polymeric colorant and has the following structure:

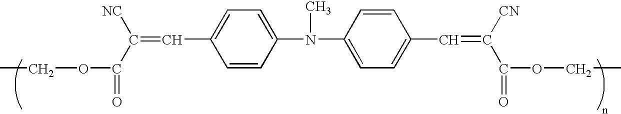

Yellow Colorant 5 is an anthraquinone type polymeric colorant and has the following structure:

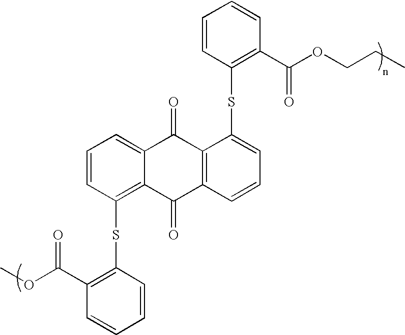

Yellow Colorant 4 and Yellow Colorant 5 are disclosed in Coloration Technology, (2003), 119(1), pp 48-56, by Weaver, et. al.

Concentrates of the polymeric yellow colorants were prepared in Eastman PET CM01 as described in Example 2. The nominal amounts of polymeric yellow colorant in each of the concentrates were the following:

Concentrate 4: 0.0025 wt % Polymeric Yellow Colorant 4

Concentrate 5: 0.015 wt % Polymeric Yellow Colorant 5

The effect of each polymeric yellow colorant on PET resin color was determined by blending the concentrate with production grade PET Resin A, using the method described in Example 2. The results are given in Table 3.

TABLE 3
Blending of Polymeric Yellow Colorants in PET Resin A

| Entry | Sample Description | disc L* | disc a* | disc b* |
|---|---|---|---|---|
| 11 | Resin A (control) | 90.53 | −0.60 | −0.08 |
| 12 | Resin A + 0.5 ppm Polymeric | 90.48 | −0.87 | 0.62 |
| | Yellow Colorant 4 | | | |
| 13 | Resin A + 1 ppm Polymeric | 90.59 | −1.16 | 1.73 |
| | Yellow Colorant 4 | | | |
| 14 | Resin A + 2 ppm Polymeric | 90.62 | −1.67 | 3.45 |
| | Yellow Colorant 4 | | | |
| 15 | Resin A + 3 ppm Polymeric | 90.31 | −0.81 | 0.85 |
| | Yellow Colorant 5 | | | |
| 16 | Resin A + 6 ppm Polymeric | 90.39 | −0.99 | 1.67 |
| | Yellow Colorant 5 | | | |
| 17 | Resin A + 12 ppm Polymeric | 90.36 | −1.34 | 3.53 |
| | Yellow Colorant 5 | | | |

The results in Table 3 show that the polymeric yellow colorants were effective at decreasing the blueness of PET Resin A which contains titanium nitride reheat particles. Advantageously, neither of the polymeric yellow colorants caused any decrease in L* (i.e. brightness). Of all the yellow colorants which were evaluated in Examples 2 and 3, the methine type polymeric Yellow Colorant 4 was the most efficient at decreasing blueness.

We claim:

1. A process for the manufacture of a polyester polymer, comprising adding:
a. reheat agent particles comprising titanium, alloys of titanium, titanium nitride, titanium boride, titanium carbide, or combinations thereof; and
b. at least one yellow colorant;
to a melt phase polymerization process for polymerizing the polyester polymer to produce a polyester polymer composition.

2. The process of claim 1, comprising adding:
c. an orange colorant, or a red colorant, or a combination thereof.

3. The process of any one of claims 2-3, wherein the polyester polymer has a b* color value ranging from greater than −2 up to +4.

4. The process of claim 3, wherein the a* color value ranges from −1 to 2.

5. The process of claim 1, comprising one or more of said reheat agent particles, wherein the reheat agent particle present in the polymer decreases the b* color value of the polymer by at least 1 units relative to the same polymer without the addition of said reheat agent particles.

6. The process of claim 5, wherein the reheat agent particle decreases the b* color value of the polymer by at least 3 units.

7. The process of claim 6, wherein the reheat agent particle decreases the b* color value of the polymer by at least 5 units.

8. The process of claim 7, wherein the composition contains a combination of a yellow colorant and an orange colorant.

9. The process of claim 7, wherein the composition contains a combination of a yellow colorant and a red colorant.

10. The process of claim 1, comprising one or more of said reheat agent particles, wherein the reheat agent particle present in the polymer reduces the UV transmission rate at 370 nm by at least 5% relative to the same polyester composition without said reheat agent particle, when measured on a polymer sample thickness of 0.012 inches.

11. The process of claim 10, wherein the percentage reduction is at least 10%.

12. The process of claim 11, wherein the percentage reduction is at least 20%.

13. The process of claim 1, wherein the reheat agent particle comprises titanium nitride.

14. The process of claim 13, wherein a yellow colorant and a red colorant are added to the melt phase process.

15. The process of claim 1, wherein the reheat agent particle comprises titanium carbide.

16. The process of claim 1, wherein the reheat agent particle comprises elemental titanium or alloys of titanium.

17. The process of claim 1, wherein the particle size of the reheat agent particles is less than 0.04.

18. The process of claim 1, wherein the amount of metals or non-metals contained in the reheat agent particles, other than carbon, nitrogen, boron, and titanium, is not greater than 30 wt. %.

19. The process of claim 18, wherein said amount is not greater than 10 wt. %.

20. The process of claim 1, wherein the reheat agent particles comprise at least 75 wt. % of all reheat agents.

21. The process of claim 20, wherein the reheat agent particles comprise at least 90 wt. % of all reheat agents.

22. The process of claim 1, wherein the amount of reheat agent particles added is effective to provide a polyester polymer containing said reheat agent particles in an amount ranging from 0.5 ppm to 1000 ppm based on the weight of the polyester polymer.

23. The process of claim 22, wherein the amount of reheat agent particles added is effective to provide a polyester polymer containing said reheat agent particles in an amount ranging from 2 ppm to 25 ppm based on the weight of the polyester polymer.

24. The process of claim 23, wherein the amount of reheat agent particles added is effective to provide a polyester polymer containing said reheat agent particles in an amount ranging from 3 ppm to 10 ppm based on the weight of the polyester polymer.

25. The process of claim 1, wherein the particle size of said reheat agent particles ranges from 1 nm to 100 nm and are added in an amount effective to provide a polyester polymer containing said reheat agent particles in an amount ranging from 3 ppm to 15 ppm.

26. The process of claim 1, wherein the particle size distribution span (S) ranges from 0 to 10.

27. The process of claim 1, wherein the reheat agent particles are added as a slurry to the melt phase polymerization.

28. The process of claim 1, wherein the polyester polymer produced by the melt phase polymerization contains reheat agent particles randomly distributed within said polymer.

29. The process of claim 1, wherein said reheat agent particles are added between esterification and polycondensation.

30. The process of claim 1, wherein said reheat agent particles are added proximate the inlet of the first polycondensation reactor.

31. The process of claim 1, wherein said reheat agent particles are added proximal to the outlet of a polycondensation final reactor.

32. The process of claim 1, wherein said reheat agent particles are added at a point after the outlet of a polycondensation reactor and before the formation of solid particles from the melt phase polymerization process.

33. The process of claim 1, wherein the reheat agent particles are added together with a reactive carrier having a number average molecular weight from 50 to 8000.

34. The process of claim 33, wherein the reactive carrier has a number average molecular weight ranging from 300 to 2000.

35. The process of claim 1, wherein a molten concentrate containing reheat agent particles is added to the melt phase polymerization.

36. The process of claim 1, wherein said polyester polymer composition has a b* color from −5 to +5.

37. The process of claim 1, wherein said polyester polymer composition has a b* color from −4 to +3.

38. The process of claim 1, wherein said polyester polymer composition has a b* color from −4 to +2.

39. The process of claim 1, wherein said polyester polymer composition has a b* color from −2.5 to +2.5.

40. The process of claim 1, wherein the reheat agent particles impart a b* color value to the polyester polymer composition less than 0 when measured in the absence of the yellow colorant.

41. The process of claim 1, wherein the polyester polymer composition has a reheat improvement temperature of at least 3° C.

42. The process of claim 1, wherein the polyester polymer composition comprises at least 95 wt % polyester polymer relative to the total weight of all polymers present in the polyester polymer composition.

43. The process of claim 1, wherein the yellow colorant is added after esterification.

44. The process of claim 43, wherein the yellow colorant is added between a final esterification reactor and a first polycondensation reactor.

45. The process of claim 44, wherein the yellow colorant is added between an outlet of a final polycondensation reactor and solidification of the polyester polymer composition.

46. The process of claim 1, wherein the yellow colorant is an organic colorant selected from the group consisting of C.I. Solvent Yellows 98, 103, 105, 113, 116, 133, 157, 162, 176, and 187; C.I. Disperse Yellows 49, 54, 64, 77, 88, 89, 93, 118, 160, 200, and 201; C.I. Pigment Yellows 1, 2, 3, 4, 5, 6, 7, 10, 11, 12, 13, 14, 15, 16, 17, 23, 24, 42, 55, 62, 63, 65, 73, 74, 75, 81, 83, 93, 94, 95, 97, 98, 108, 109, 110, 111, 113, 120, 127, 128, 129, 130, 133, 136, 138, 139, 147, 150, 151, 154, 155, 156, 168, 169, 174, 175, 180, 181, 190, 191, 194, 199, and C.I. Vat Yellows 1, 3, and 20.

47. The process of claim 1, wherein the colorant is added in a liquid carrier, said yellow colorant selected from the group consisting of C.I. Solvent Yellows 98, 103, 105, 113, 116, 133, 157, 162, 176, and 187; C.I. Disperse Yellows 49, 54, 64, 77, 88, 89, 93, 118, 160, 200, and 201; C.I. Pigment Yellows 1, 2, 3, 4, 5, 6, 7, 10, 11, 12, 13, 14, 15, 16, 17, 23, 24, 42, 55, 62, 63, 65, 73, 74, 75, 81, 83, 93, 94, 95, 97, 98, 108, 109, 110, 111, 113, 120, 127, 128, 129, 130, 133, 136, 138, 139, 147, 150, 151, 154, 155, 156, 168, 169, 174, 175, 180, 181, 190, 191, 194, 199, and C.I. Vat Yellows 1, 3, and 20.

48. The process of claim 42, wherein the liquid carrier is soluble in the polyester polymer.

49. The process of claim 1, wherein the amount of yellow colorant added is less than 100 ppm.

50. The process claim 49, wherein the amount of yellow colorant added is 15 ppm or less.

51. The process of claim 50, wherein the amount yellow colorant added is 5 ppm or less.

52. The process of claim 51, wherein the amount of yellow colorant added is 3 ppm or less.

53. The process of claim 1, wherein the molecular weight of the yellow colorant ranges from 400 to 20,000.

54. The process of claim 1, wherein the amount of yellow colorant added is effective to produce a polyester polymer composition having a b* ranging from −2.5 to +4.

55. The process of claim 1, wherein the amount of yellow colorant added is effective to produce a polyester polymer composition having a b* ranging from −0 to +3.

56. The process of claim 1, wherein the amount of yellow colorant added is shifts the b* color of the polyester polymer composition by at least 1 unit on the CIELAB color scale, relative to the same polyester polymer composition without the yellow colorant.

57. The process of claim 56, wherein the yellow colorant added shifts the b* color of the polyester polymer composition by at least 2 units on the CIELAB color scale, relative to the same polyester polymer composition without the yellow colorant.

58. The process of claim 57, wherein the yellow colorant added shifts the b* color of the polyester polymer composition by at least 3 units on the CIELAB color scale, relative to the same polyester polymer composition without the yellow colorant.

59. The process of claim 1, wherein the yellow colorant comprises: 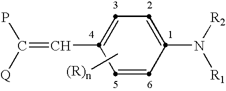
wherein (R)n represents a —CH₃ group at the 3 position, R₁ and R₂ are each 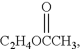
P is CN, and Q is CO₂CH₃;
ethyl [[4-(dimethylamino)phenyl]methylene]propenedioate; or
1,5-bis(2-carboxyphenylthio)anthraquinone.

60. The process of claim 1, wherein the polyester polymer composition comprises a polyethylene terephthalate polymer or copolymer obtained by reacting a carboxylic acid component comprising at least 85 mole % terephthalic acid or C₁-C₄ dialkylterephthalate, and a hydroxyl component comprising at least 60 mole % ethylene glycol.

61. The process of claim 1, wherein the polyester polymer composition comprises a polyethylene terephthalate polymer or copolymer containing at ethylene terephthalate residues in an amount of at least 80 mole % based on the polymer.

62. The process of claim 1, wherein the It.V. of the polyester polymer composition is more than 0.70 dL/g obtained from the melt phase polymerization.

63. The process of claim 62, wherein the It.V. of the polyester polymer composition is at least 0.74 dL/g obtained from the melt phase polymerization.

64. A process for increasing the yellowness of an article, comprising adding to a melt processing zone for making an article a primary feed of polyester polymer particles and:
a) reheat agent particles comprising titanium, alloys of titanium, titanium nitride, titanium boride, titanium carbide, or combinations thereof, and
c) a yellow colorant.

65. The process of claim 64, wherein the reheat agent particles are contained within the primary feed of polyester polymer particles fed to the melt processing zone.

66. The process of claim 64, wherein no reheat agents are added to the melt processing zone beyond the reheat agent particles contained within the primary feed of polyester polymer particles.

67. The process of claim 64, wherein the yellow colorant is contained within the polyester polymer particles.

68. The process of claim 67, wherein no yellow colorant is added to the melt processing zone beyond the yellow colorant contained within the primary feed of polyester polymer particles.

69. The process of claim 64, wherein the yellow colorant and the reheat agent particles are contained within the primary feed of polyester polymer particles fed to the melt processing zone.

70. The process of claim 64, wherein the polyester polymer particles in said primary feed either:
(i) do not contain any of said reheat agent particles, yellow colorants, or both, or
(ii) contain said reheat agent, yellow colorant, or both, but at a lower concentration of reheat agent particles, yellow colorant, or both than present in the article.

71. The process of claim 70, further comprising, in addition to the primary feed of polyester polymer particles, feeding reheat agent particles to the melt processing zone.

72. The process of claim 71, wherein said feed of reheat agent particles is combined with the primary feed of polyester polymer particles to form a combined stream fed to the melt processing zone.

73. The process of claim 71, wherein said reheat agent particles and said polyester polymer particles are fed as separate feed streams to the melt processing zone.

74. The process of claim 70, comprising, in addition to the primary feed of polyester polymer particles, letting down a concentrate to the melt processing zone, said concentrate comprising a polyester polymer and reheat agent particles.

75. The process of claim 70, further comprising, in addition to the primary feed of polyester polymer particles, feeding a yellow colorant to the melt processing zone.

76. The process of claim 75, wherein said feed of yellow colorant is combined with the primary feed of polyester polymer particles to form a combined stream fed to the melt processing zone.

77. The process of claim 75, wherein said yellow colorant and said primary feed of polyester polymer particles are fed as separate feed streams to the melt processing zone.

78. The process of claim 77, wherein the yellow colorant is fed as a separate stream in a liquid carrier.

79. The process of claim 70, further comprising, in addition to the primary feed of polyester polymer particles, feeding a concentrate to the melt processing zone, said concentrate comprising a polyester polymer and a yellow colorant.

80. The process of claim 64, further comprising, in addition to the primary feed of polyester polymer particles, feeding reheat agent particles and yellow colorant to the melt processing zone.

81. The process of claim 80, comprising feeding a concentrate of polyester polymer particles to the melt processing zone as a secondary feed of polyester polymer particles, wherein said concentrate comprises a polyester polymer, yellow colorant, and reheat agent particles.

82. The process of claim 80, wherein reheat agent particles, yellow colorant, and primary feed of polyester polymer particles are fed as separate feed streams to the melt processing zone.

83. The process of claim 79, wherein the feed of reheat agent particles are let down into the melt processing zone as a concentrate comprising said reheat agent particles and a polyester polymer, and said feed of yellow colorant is fed to the melt processing zone as a liquid.

84. The process of claim 64, wherein the articles comprise a molded preform.

85. The process of claim 84, comprising blow molding the preform to produce a beverage bottle.

86. The process of claim 85, wherein the bottle has a b* color within the range of −5 to +2.5 and has an L* of at least 70.

87. An article comprising a bottle preform or a bottle, said preform or said bottle comprising a polyester polymer, a yellow colorant, and reheat agent particles comprising titanium, alloys of titanium, titanium nitride, titanium boride, titanium carbide, or combinations thereof.

88. The article of claim 87, wherein the article has a b* color within the range of −5 to +4.

89. The articles of claim 88, wherein the article has an L* of at least 70.

90. The article of claim 87, wherein the article has a b* color ranging from −2.5 to +4.

91. The article of any one of claim 87-90, wherein the reheat agent particles comprise titanium nitride.

92. The article of any one of claims 87-90, wherein the article contains residues of a catalyst metal selected from the group consisting of titanium, aluminum, lithium, germanium, or combinations thereof.

93. The article of claim 87, wherein the article further comprises a red colorant.

94. The article of claim 87, wherein the amount of reheat agent particles ranges from 2 ppm to 25 ppm based on the weight of the article.

95. The article of claim 87, wherein the amount of reheat agent particles ranges from 3 ppm to 10 ppm based on the weight of the article.

96. The article of claim 87, wherein the particle size of said reheat agent particles ranges from 1 nm to 100 nm and are present in an amount ranging from 3 ppm to 15 ppm.

97. The article of claim 96, wherein the said reheat agent particle provide a reheat improvement temperature to the article of at least 3° C.

98. The article of claim 87, wherein the yellow colorant is an organic colorant selected from the group consisting of C.I. Solvent Yellows 98, 103, 105, 113, 116, 133, 157, 162, 176, and 187; C.I. Disperse Yellows 49, 54, 64, 77, 88, 89, 93, 118, 160, 200, and 201; C.I. Pigment Yellows 1, 2, 3, 4, 5, 6, 7, 10, 11, 12, 13, 14, 15, 16, 17, 23, 24, 42, 55, 62, 63, 65, 73, 74, 75, 81, 83, 93, 94, 95, 97, 98, 108, 109, 110, 111, 113, 120, 127, 128, 129, 130, 133, 136, 138, 139, 147, 150, 151, 154, 155, 156, 168, 169, 174, 175, 180, 181, 190, 191, 194, 199, and C.I. Vat Yellows 1, 3, and 20.

99. The article of claim 87, wherein the yellow colorant is organic and present in an amount of less than 100 ppm.

100. The article of claim 99, wherein the amount of yellow colorant is 15 ppm or less.

101. The article of claim 100, wherein the amount of yellow colorant is 5 ppm or less.

102. The article of claim 87, wherein the article further contains an orange colorant.

103. The article of claim 87, wherein the amount of yellow colorant shifts the b* color of the article by at least 1 unit on the CIELAB color scale, relative to the same article without the yellow colorant.

104. The article of claim 103, wherein the shift is by at least 2 units.

105. The article of claim 104, wherein the shift is by at least 3 units.

106. The article of claim 87, wherein the yellow colorant comprises: 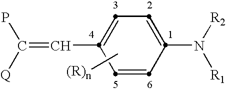
wherein (R)n represents a —CH₃ group at the 3 position, R₁ and R₂ are each 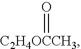
P is CN, and Q is CO₂CH₃;
ethyl [[4-(dimethylamino)phenyl]methylene]propenedioate; or
1,5-bis(2-carboxyphenylthio)anthraquinone.

107. The article of claim 87, wherein the polyester polymer comprises a polyethylene terephthalate polymer or copolymer obtained by reacting a carboxylic acid component comprising at least 85 mole % terephthalic acid or C₁-C₄ dialkylterephthalate, and a hydroxyl component comprising at least 60 mole % ethylene glycol.

108. The article of claim 87, wherein the polyester polymer used to make the article has an It.V. of greater than 0.70 dL/g and has not be solid state polymerized, said polyester polymer comprising a polyethylene terephthalate polymer or copolymer obtained by reacting a carboxylic acid component comprising at least 85 mole % terephthalic acid or C₁-C₄ dialkylterephthalate, and a hydroxyl component comprising at least 85 mole % ethylene glycol.

109. The article of claim 108, wherein the It.V. of said polyester polymer is at least 0.76 dL/g.

110. The article of claim 87, comprising a preform having a b* ranging from −3 to +3.

111. The article of claim 110, having an L* of at least 70.

112. A shipping container containing polyester polymer particles having an It.V. of at least 0.70 and which have not been solid state polymerized, said polyester polymer particles comprising a polyester polymer, a yellow colorant, and reheat agent particles comprising titanium, alloys of titanium, titanium nitride, titanium boride, titanium carbide, or combinations thereof.

113. The container of claim 112, wherein the It.V. of the particles is at least 0.76 dL/g.

114. The container of claim 113, wherein the polyester polymer particles have a degree of crystallinity of at least 30%.

115. The container of claim 114, wherein the reheat agent particles comprise titanium nitride.

116. The container of claim 114, wherein the volume of the polyester polymer particles is at least 5 cubic meters.

117. The container of claim 1 16, wherein the reheat agent particles are randomly distributed within the polyester polymer.

118. The container of claim 112, wherein the polyester particles further contain a red colorant.

119. The container of claim 112, wherein the polyester particles further contain an orange colorant.

120. A concentrate comprising a polyester polymer, a yellow colorant, and reheat agent particles comprising titanium, alloys of titanium, titanium nitride, titanium boride, titanium carbide, or combinations thereof, wherein the concentration of yellow colorant or reheat agent particles or both is at least 1000 ppm based on the weight of the concentrate.

121. The concentrate of claim 120, wherein the concentration is at least 2000 ppm.

122. The concentrate of claim 120, wherein the concentration of the reheat agent particles is at least 5000 ppm.

123. The concentrate of claim 120, wherein the concentration is at least 10,000 ppm.

124. The concentrate of claim 120, wherein the It.V. of the polyester polymer in the concentrate is within ±0.10 of the It.V. of the polyester polymer particles fed to the melt processing zone.

125. The process of claim 1, wherein said yellow colorant comprises a polymeric yellow colorant.

126. The process of claim 64, wherein said yellow colorant comprises a polymeric colorant.

127. The article of claim 87, wherein said yellow colorant comprises a polymeric colorant, and said article comprises a stretch blow molded bottle.

128. The container of claim 112, wherein said yellow colorant comprises a polymeric colorant.

129. The article of claim 87, wherein said article comprises a bottle preform.

130. The article of claim 87, wherein said article comprises a stretch blow molded bottle.

131. The article of claim 87, wherein said article comprises a carbonated drink bottle.

132. The article of claim 87, wherein said article comprises a still water bottle.
